(19) United States
(12) Patent Application Publication
(10) Pub. No.: US 2003/0155517 A1
(43) Pub. Date: Aug. 21, 2003

(54) Radiation detecting element, radiation image pickup apparatus and radiation detecting method

(75) Inventors: Takahiro Numai, Kanagawa (JP); Masakazu Morishita, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/368,555

(22) Filed: Feb. 20, 2003

(30) Foreign Application Priority Data
Feb. 20, 2002 (JP) 2002-043580

(51) Int. Cl. G01T 1/24

(52) U.S. Cl. 250/370.09

(57) ABSTRACT

The invention is to realize a radiation detecting element of an excellent sensitivity to the incident radiation, and to provide a radiation image pickup apparatus showing a low dark current generating noises and having a satisfactory resolution. A carrier diffusion preventing layer is provided between a charge emitting layer 20 and at least either of a 10 first semiconductor layer and a second semiconductor layer 20 to prevent a carrier diffusion from such either semiconductor layer to the charge emitting layer, thereby reducing the dark current caused by the trap level. It is thus possible to improve the carrier capture efficiency and to realize the radiation detecting element of a high sensitivity.

### BACKGROUND OF THE INVENTION

1. Field of the Invention

The present invention relates to a radiation detecting element, a radiation image pickup apparatus and a radiation detecting method, and is particularly adapted for use in an X-ray image pickup apparatus for obtaining an electronic image from a radiation image such as formed by X-ray transmitted by a specimen such as a human body.

2. Related Background Art

As a high-speed radiation detecting element for outputting an image on real-time basis, a semiconductor radiation detector is attracting attention. However, such semiconductor radiation detector is associated with a dark current constituting a noise. It is described, for example, in Nuclear Instruments and Methods in Physics Research, A434, pp.44-56.

Such semiconductor radiation detector is associated with a drawback that a current generated from a trap level in a charge emitting layer is predominant and such dark current generates a noise whereby a weak signal cannot be detected.

In consideration of the foregoing, the present invention is to provide a radiation detecting element having excellent sensitivity characteristics to an incident radiation, thereby providing a radiation image pickup apparatus with a reduced dark current which is a factor of noises and with a satisfactory resolution.

### SUMMARY OF THE INVENTION

A radiation detecting element of the present invention includes a charge emitting layer which absorbs a radiation and emits a charge, a first semiconductor layer, a second semiconductor layer of a conductive type opposite to that of the first semiconductor layer, wherein the charge emitting layer is provided between the first semiconductor layer and the second semiconductor layer, and a carrier diffusion preventing layer which is provided between the charge emitting layer and at least either of the first semiconductor layer and the second semiconductor layer, thereby preventing a carrier diffusion from at least either semiconductor layer to the charge emitting layer.

A radiation image pickup apparatus of the present invention includes an input pixel having an aforementioned radiation detecting element, charge accumulation means for accumulating a charge converted from a radiation by the radiation detecting element, control means for controlling an electric field applied to the radiation detecting element and readout means for reading a signal based on the charge accumulated in the charge accumulation means, an output line for outputting a signal, read by the readout means, from the input pixel, and reset means for resetting the charge accumulation means to a predetermined voltage.

Also a radiation detecting method of the present invention utilizes a radiation detecting element including a charge emitting layer which absorbs a radiation and emits a charge, and which is provided between a first semiconductor layer and a second semiconductor layer of a conductive type opposite to that of the first semiconductor layer, prevents, by a carrier diffusion preventing layer provided between the charge emitting layer and at least either of the first semiconductor layer and the second semiconductor layer, a carrier diffusion from the at least either semiconductor layer to the charge emitting layer.

Details of the invention will be described later.

### BRIEF DESCRIPTION OF THE DRAWINGS

FIG. 1 is a schematic cross-sectional view of a radiation detecting element in a first embodiment of the present invention;

FIG. 2 is an energy band chart showing a trap level of the radiation detecting element;

FIG. 3 is a schematic cross-sectional view of a radiation detecting element in the first embodiment of the present invention;

FIG. 4 is a chart showing characteristics between a distance from an interface between an n-layer and an electrode, and an electron density;

FIG. 5 is a chart showing a relationship between a carrier capturing efficiency in a radiation detecting element and a voltage applied thereto;

FIG. 6 is a characteristic chart showing an example of an X-ray energy and an absorption ratio thereof in Si and Ge;

FIG. 7 is a chart showing characteristics between a dark current resulting from a pn junction or a pin junction of a semiconductor and a band gap energy;

FIG. 8 is a characteristic chart showing a radiation energy required for generating carriers in a radiation irradiation of a semiconductor;

FIG. 9 is a chart showing characteristics between a voltage applied to a depletion layer and a thickness of the depletion layer in the case of Si;

FIG. 10 is a chart showing characteristics between a voltage applied to a depletion layer and a thickness of the depletion layer in the case of GaAs;

FIG. 11 is a schematic cross-sectional view of a radiation image pickup apparatus in a second embodiment of the present invention;

FIG. 12 is an equivalent circuit diagram of the radiation image pickup apparatus in the second embodiment of the present invention;

FIG. 13 is a view showing a configuration of an output circuit;

FIGS. 14A and 14B are a plan view of a readout unit and a schematic cross-sectional view along a line 14B-14B in FIG. 14A, respectively;

FIGS. 15A, 15B, 15C and 15D are an equivalent circuit diagram and potential charts of a unit cell of the radiation image pickup apparatus of the second embodiment;

FIG. 16 is a timing chart of a driving operation of the radiation image pickup apparatus of the second embodiment;

FIG. 17 is a chart showing a relationship between an applied voltage and a depletion layer thickness, taking resistivity of n-type or p-type Si as a parameter;

FIG. 18 is a chart showing X-ray absorbing characteristics of TiBr, CsI and Se;

FIG. 19 is a schematic cross-sectional view of a variation of the radiation image pickup apparatus of the second embodiment, employing a high-resistance semiconductor in a single crystal semiconductor of an X-ray sensing unit in FIG. 11;

FIG. 20 is a schematic cross-sectional view showing another variation of the radiation image pickup apparatus of the second embodiment;

FIG. 21 is a schematic cross-sectional view showing another variation of the radiation image pickup apparatus of the second embodiment;

FIG. 22 is a schematic cross-sectional view showing another variation of the radiation image pickup apparatus of the second embodiment;

FIG. 23 is an equivalent circuit diagram of a radiation image pickup apparatus of a third embodiment;

FIG. 24 is a timing chart of a driving operation of the radiation image pickup apparatus of the third embodiment;

FIG. 25 is an equivalent circuit diagram of a unit cell of the radiation image pickup apparatus of the third embodiment, in which a reset transistor is provided in an accumulating capacitor;

FIG. 26 is an equivalent circuit diagram of a unit cell of the radiation image pickup apparatus of the third embodiment, in which reset transistors are provided at the same time;

FIG. 27 is an equivalent circuit diagram of a radiation image pickup apparatus of a fourth embodiment;

FIG. 28 is an equivalent circuit diagram of the radiation image pickup apparatus shown in FIG. 23, in which a source follower is provided in a second transistor;

FIG. 29 is an equivalent circuit diagram of the radiation image pickup apparatus shown in FIG. 25, in which a source follower is provided in a second transistor;

FIG. 30 is an equivalent circuit diagram of the radiation image pickup apparatus shown in FIG. 26, in which a source follower is provided in a second transistor;

FIG. 31 is an equivalent circuit diagram of a radiation image pickup apparatus of a fifth embodiment;

FIG. 32 is a schematic cross-sectional view of a radiation image pickup apparatus of a sixth embodiment;

FIG. 33 is an equivalent circuit diagram of the radiation image pickup apparatus of the sixth embodiment;

FIG. 34 is a timing chart showing a driving operation of the radiation image pickup apparatus of the sixth embodiment;

FIG. 35 is a schematic cross-sectional view showing a variation of the radiation image pickup apparatus of the sixth embodiment;

FIG. 36 is a schematic cross-sectional view showing another variation of the radiation image pickup apparatus of the sixth embodiment;

FIG. 37 is a schematic cross-sectional view showing still another variation of the radiation image pickup apparatus of the sixth embodiment;

FIG. 38 is a schematic cross-sectional view showing still another variation of the radiation image pickup apparatus of the sixth embodiment;

FIG. 39 is a schematic cross-sectional view showing still another variation of the radiation image pickup apparatus of the sixth embodiment;

FIG. 40 is an equivalent circuit diagram of a radiation image pickup apparatus of a seventh embodiment;

FIG. 41 is a timing chart showing a driving operation of the radiation image pickup apparatus of the seventh embodiment;

FIG. 42 is a schematic view showing the configuration of a radiation image pickup apparatus of an eighth embodiment; and

FIG. 43 is a view showing an example of a medical diagnostic equipment employing a radiation image pickup apparatus in a ninth embodiment of the present invention.

### DETAILED DESCRIPTION OF THE PREFERRED EMBODIMENTS

In the following, there will be given a detailed explanation on embodiments of the radiation detecting element and the radiation image pickup apparatus of the present invention, with reference to the accompanying drawings. In these embodiments, there will be shown a case of employing X-ray as the radiation, but the radiation in the present invention is not limited to X-ray but includes also electromagnetic waves such as α-ray, β-ray, γ-ray etc.

(First Embodiment)

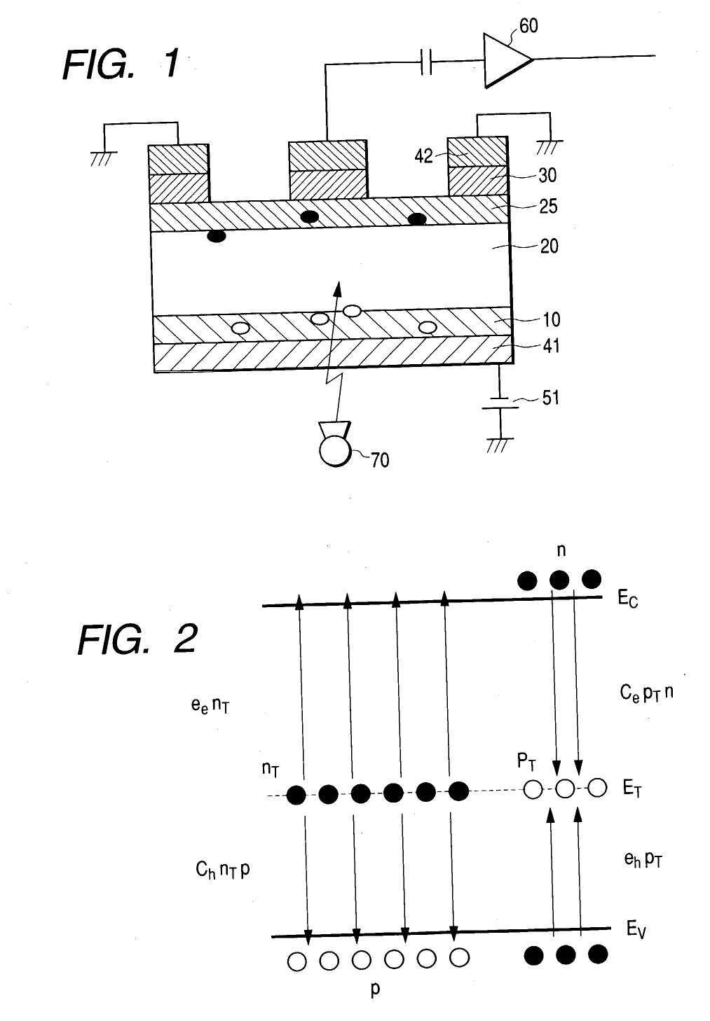

FIG. 1 is a schematic cross-sectional view of a radiation detecting element in a first embodiment of the present invention. Referring to FIG. 1, there are shown a p-layer constituted by a semiconductor such as GaAs, GaP, Ge or Si, and an i-layer 20 constituting a charge emitting layer which absorbs a radiation and emits electrons and generates an electron and a hole by X-ray irradiation. The i-layer 20 has a low carrier concentration. Therefore, an i-layer 20 of n-type is represented as n-type (ν type) and an i-layer 20 of p-type is represented as p-type (π type).

There are also shown a p-layer 25, an n-layer 30, and electrodes 41, 42 formed by metal layers. The p-layer 25 functions as a carrier diffusion preventing layer, which features the present invention and prevents diffusion of electrons from the n-layer 30 to the charge emitting i-layer 20. The p-layer 25 is so selected as to form a pn junction with the nearby n-layer 30, and, as will be explained later, the layer 25 can be made n-type in the case the layer 30 is p-type. The electrode 41 is connected with an amplifier 60 for amplifying an electric signal taken out from the radiation detecting element through a capacitor. The radiation detecting element is connected to a power source 51 for controlling an electric field in the i-layer 20, and is rendered capable of capturing carriers generated by a radiation applied from a radiation source 70.

The charge emitting i-layer 20 often has a trap level. FIG. 2 is an energy band chart showing a trap level of the radiation detecting element, wherein Ec indicates a bottom of a conduction band, Ev indicates a top of a valence band, and E_{T} indicates a trap level. A black circle indicates an electron and a white circle indicates a hole. Also n_{T} indicates a concentration of trap levels occupied by electrons, p_{T} indicates a concentration of empty trap levels not occupied by electrons, n indicates a concentration of conduction electrons, p indicates a concentration of holes, and an arrow indicates a transition process (direction of arrow indicating a direction of electron transition).

An electron transition rate from the trap level E_{T} to the conduction band can be represented as eₑn_{T}, and an electron transition rate from the conduction band to the trap level E_{T} can be represented as Cₑp_{T}n. Similarly, a hole transition rate from the trap level E_{T} to the valence band can be represented as eₕp_{T}, and a hole transition rate from the valence band to the trap level E_{T} can be represented as Cₕn_{T}p, wherein eₑ and eₕ are an electron emission rate and a hole emission rate, respectively, and Cₑ and Cₕ are an electron capture coefficient and a hole capture coefficient, respectively.

The electron capture coefficient Cₑ can be represented by a product of an electron capture cross section σₑ and a thermal velocity vₑₜₕ of a conduction electron (Cₑ=σₑvₑₜₕ), and the hole capture coefficient Cₕ can be represented by a product of a hole capture cross section σₕ and a thermal velocity Vₑₜₕ of a hole (Cₕ=σvₕₜₕ).

As a result, in the case the charge emitting i-layer 20 is isolated, a rate equation for the conduction electrons and the holes can be represented by equations (1) and (2), respectively:

$$\begin{matrix}\frac{ⅆ n}{ⅆ t} = {e}_{e} {n}_{T} - {C}_{e} {p}_{T} n \\ \frac{ⅆ p}{ⅆ t} = {e}_{h} {p}_{T} - {C}_{h} {n}_{T} p\end{matrix} \qquad equation ( 1 ) and ( 2 )$$

At first, let us consider the concentration of the conduction electrons. Based on the equation (1), an electron concentration N_{B} in the charge emitting i-layer. 20 in a stationary state is given by an equation (3).

$$n = {N}_{B} = \frac{{e}_{e} {n}_{T}}{{C}_{e} {p}_{T}} . \qquad equation ( 3 )$$

On the other hand, in the case a junction is formed by the p-layer 10 or the n-layer 30 and the charge emitting i-layer 20, in a thermal equilibrium state, the electrons and the holes are diffused in such a manner that the Fermi levels coincide in both layers, whereby the junction interface is depleted. Considering an effect that such diffusion increases the electrons in the charge emitting i-layer 20, the rate equation for the electrons in the charge emitting i-layer 20 is modified as shown in an equation (4).

$$\frac{ⅆ n}{ⅆ t} = {e}_{e} {n}_{T} - {C}_{e} {p}_{T} n + {D}_{e} {∇}^{2} n \qquad equation ( 4 )$$

wherein Dₑ is a diffusion constant for the electrons diffusing from the junction layer to the charge emitting i-layer 20.

Now, in the absence of the trap level E_{T}, assuming that a diffusion current and a drift current mutually cancel in a thermal equilibrium state, an equation (5) can be obtained utilizing a relaxation time approximation.

$${D}_{e} {∇}^{2} n = \frac{n - {n}_{0}}{{τ}_{ec}} \qquad equation ( 5 )$$

wherein n₀ indicates an electron concentration in the junction layer prior to the formation of a junction, and τ_{ec} is an average collision time of the electrons. A substitution of the equation (5) in the equation (4) provides an equation (6).

$$\frac{ⅆ n}{ⅆ t} = {e}_{e} {n}_{T} - {C}_{e} {p}_{T} n + \frac{n - {n}_{0}}{{τ}_{ec}} \qquad equation ( 6 )$$

Consequently, in a stationary state, an electron concentration nₛ in the depleted charge is written as

$${n}_{s} = {( {C}_{e} {p}_{T} - \frac{1}{{τ}_{ec}} )}^{- 1} ( {e}_{e} {n}_{T} - \frac{{n}_{0}}{{τ}_{ec}} ) \qquad equation ( 7 )$$

For a drift velocity v_{ed} of the electrons, a current density J_{eg} by the electrons generated from the trap level E_{T} is given by an equation (8).

$${J}_{eg} = {en}_{s} {v}_{ed} = {e ( {C}_{e} {p}_{T} - \frac{1}{{τ}_{ec}} )}^{- 1} ( {e}_{e} {n}_{T} - \frac{{n}_{0}}{{τ}_{ec}} ) {v}_{ed} \qquad equation ( 8 )$$

Similarly, a current density J_{hg} by the holes generated from the trap level E_{T} can be represented by an equation (9).

$${J}_{hg} = {e ( {C}_{h} {n}_{T} - \frac{1}{{τ}_{hc}} )}^{- 1} ( {e}_{h} {p}_{T} - \frac{{p}_{0}}{{τ}_{hc}} ) {v}_{hd} \qquad equation ( 9 )$$

wherein v_{hd} indicates a drift velocity of the holes.

A current by the carriers generated from the trap level E_{T} is given by a sum of (8) and (9) Consequently, it will be understood from these equations that the dark current becomes larger as the concentrations of the electrons and the holes diffusing from the semiconductor layers to the charge emitting i-layer 20 increase.

Also, in the case the carriers diffusing to the charge-emitting i-layer 20 are captured in the trap level E_{T}, the dark current becomes larger because of an increase in the carriers generated from the trap level E_{T}. Therefore, an interception of the carriers that can be captured by the trap level E_{T} by a carrier diffusion preventing layer is effective in reducing the dark current. For example, for such a trap level E_{T} as EL2 in GaAs, it is effective to intercept the electrons diffusing from the n-layer 30 to the i-layer 20.

In the case the electron drift velocity v_{ed} is sufficiently larger than the hole drift velocity v_{hd}, the dark current is governed by the equation (8). Also in this case, it is effective to reduce the concentration of the electrons diffusing from the n-layer 30 to the charge emitting i-layer 20 in order to reduce the dark current.

For this purpose, a p-layer 25, which is a p-type semiconductor layer, may be inserted between the n-layer 30 and the i-layer 20, because the electrons diffusing from the n-layer 30 toward the i-layer 20 recombine with the holes in the p-layer 25 provided therebetween, and thus cannot reach the i-layer 20.

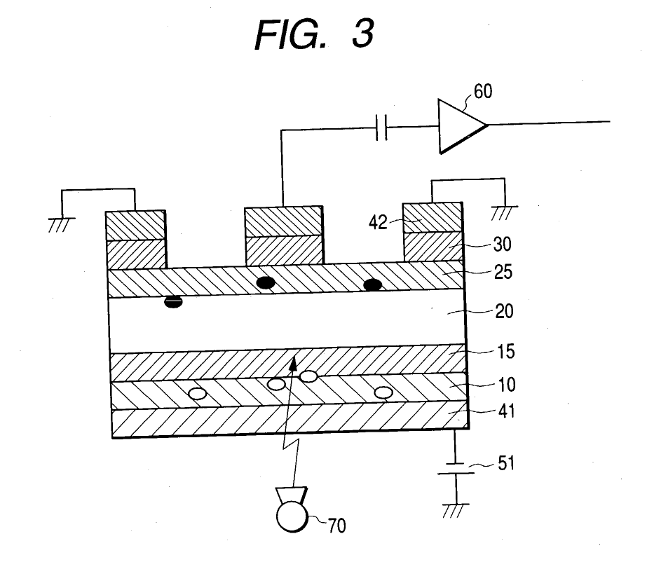

Also in the case a current by the holes is governing in the dark current, an n-layer 15 may be additionally inserted between the p-layer 10 and the charge emitting i-layer 20 as shown in FIG. 3.

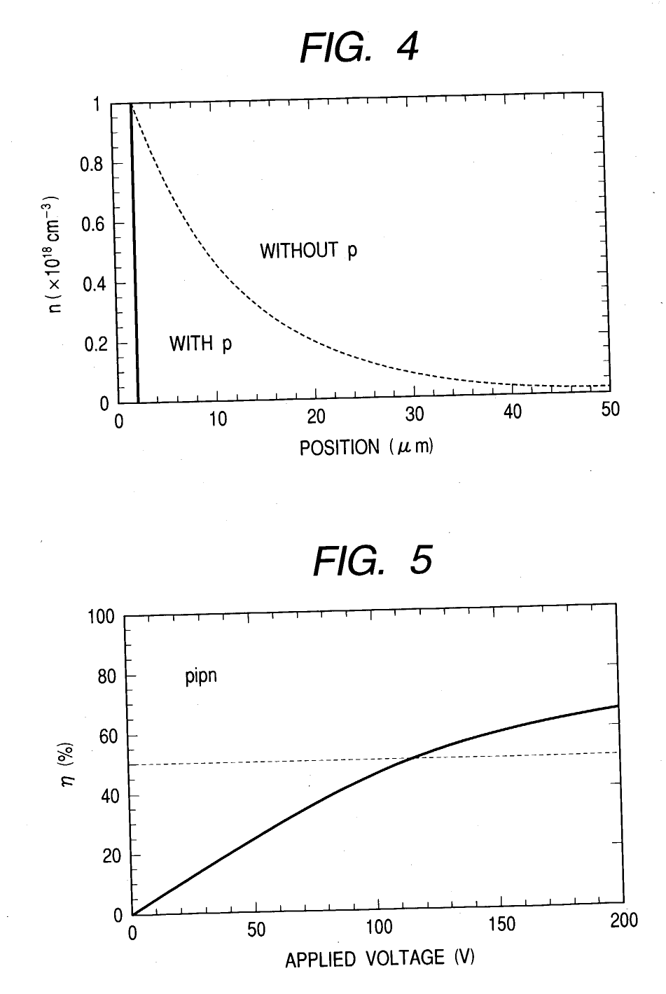

FIG. 4 is a chart showing characteristics between a distance from an interface between the n-layer 30 and the electrode 42 in the radiation detecting apparatus, and the electron concentration. In FIG. 4, a broken line indicates an electron concentration in the absence of the p-layer 25 between the n-layer 30 (electron concentratin 10¹⁸ cm⁻³, thickness 2 μm) and the charge emitting i-layer 20 (electron concentratin 10⁷ cm⁻³, thickness 600 μm), and a solid line indicates an electron concentration in the case a p-layer 25 (hole concentratin 10¹⁹ cm⁻³, thickness 1 μm) is inserted between the n-layer 30 and the charge emitting i-layer 20.

An electron diffusion length, which is 10.7 μm in the absence of the p-layer 25 between the n-layer 30 and the i-layer 20, is reduced to 0.18 μm when the p-layer 25 is inserted between the n-layer 30 and the i-layer 20. This result suggests that the dark current is lowered by about two orders by the insertion of the p-layer 25, in comparison with a case without the p-layer 25.

Next, a carrier capturing efficiency is considered. It is assumed that an X-ray irradiation from the radiation source 70 shown in FIG. 1 provides an electron concentration n=nₛ+Δn (nₛ being a constant value in the absence of the X-ray irradiation). An equation (10) is obtained by substituting this equation into (6).

$$\frac{ⅆ}{ⅆ t} Δ n = - {C}_{e} {p}_{T} Δ n + \frac{Δ n}{{τ}_{ec}} \qquad equation ( 10 )$$

In the right-hand side of the equation (10), a first term indicates an electron extinction by the trap level E_{T}, and a second term indicates a rate of the electrons going toward the electrode.

Taking α_{eT} as an attenuation coefficient of the electron concentration by the trap level E_{T}, an equation (11) is derived.

$$\frac{ⅆ}{ⅆ z} Δ n = - {α}_{eT} Δ n = \frac{ⅆ t}{ⅆ z} \frac{ⅆ}{ⅆ t} Δ n = \frac{1}{{v}_{ed}} \frac{ⅆ}{ⅆ t} Δ n \qquad equation ( 11 )$$

wherein v_{ed} is a drift velocity of the electrons. From a comparison of the first term in the right-hand side of the equation (10) and the equation (11), the attenuation coefficient α_{eT} is given by an equation (12).

$${α}_{cT} = \frac{{C}_{e} {p}_{T}}{{v}_{ed}} \qquad equation ( 12 )$$

On the other hand, assuming a DQE=0.7 for a depletion layer width W=1 mm, the spatial distribution of the electron concentration Δn in average is given by an equation (13).

Δn=Δn₀exp(−αₛx), αₛ=12.04 cm⁻¹ equation (13)

From the foregoing, an electron capture efficiency η is given by an equation (14).

$$\begin{matrix}η = \frac{{\int }_{0}^{W} Δ {n}_{0} exp ( - {α}_{s} x ) exp [ - {α}_{eT} ( W - x ) ] ⅆ x}{{\int }_{0}^{W} Δ {n}_{0} exp ( - {α}_{s} x ) ⅆ x} \\ = \frac{{α}_{s} exp ( - {α}_{eT} W )}{{α}_{s} - {α}_{eT}} \cdot \frac{1 - exp [ - ( {α}_{s} - {α}_{eT} ) W ]}{1 - exp ( - {α}_{s} W )}\end{matrix} \qquad equation ( 14 )$$

This result is shown in FIG. 5.

FIG. 5 is a chart showing the relationship between a carrier capture efficiency in a radiation detecting element and a voltage applied thereto. The radiation detecting apparatus corresponding to FIG. 5 has a layer 25 (hole concentration 10¹⁹ cm⁻³, thickness 1 μm) is inserted between an n-layer 30 and an i-layer 20 and has a depletion layer width W=600 μm and a trap level concentration N_{T}=10¹⁶ cm⁻³. From FIG. 5, it is understood that an electron capture efficiency η=50% can be met at an applied voltage of 113 V or higher.

A high capture efficiency can be obtained even in the case the p-layer 25 is inserted between the n-layer 30 and the i-layer 20 because the carriers generated by X-ray absorption are accelerated by the electric field, so that the electrons can mostly reach the electrode 42 before recombining with the holes in the p-layer 25.

On the other hand, the electrons diffusing from the n-layer 30 toward the i-layer 20 are decelerated by the electric field and at the same time recombine with the holes in the p-layer 25, thus becoming unable to reach the i-layer 20.

As explained in the foregoing, the p-layer 25 inserted between the n-layer 30 and the i-layer 20 intercepts the diffusing electrons while it can transmit a major portion of the electrons generated in the i-layer 20 by X-ray absorption.

What has been explained in the foregoing also applies to a case where an n-layer 15 is inserted between a p-layer 10 and an i-layer 20 shown in FIG. 3. More specifically, the n-layer 15 inserted between the p-layer 10 and the i-layer 20 intercepts the diffusion of the holes but transmits a major portion of the holes generated in the i-layer 20 by X-ray absorption.

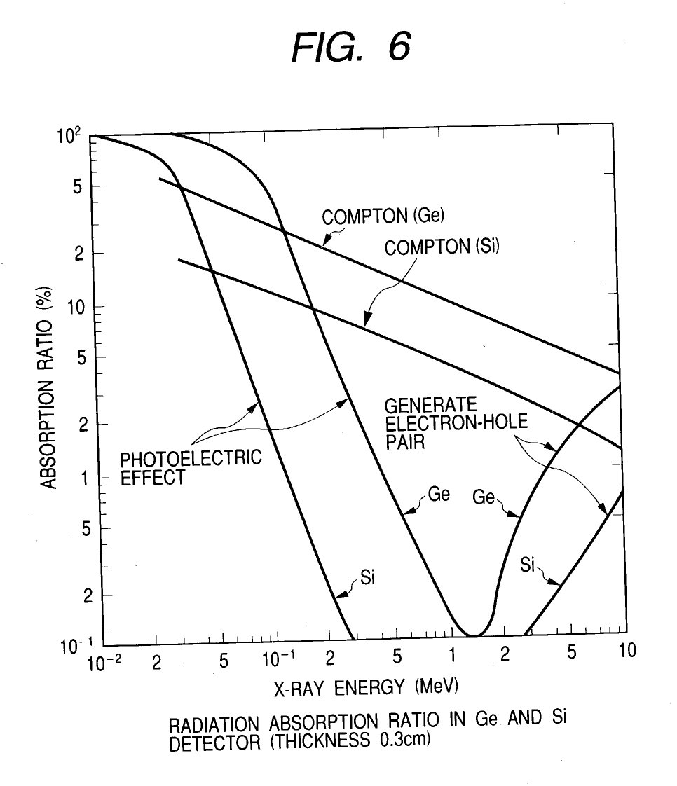

In the radiation detecting element shown in FIG. 1, an absorption of X-ray or γ-ray in a semiconductor constituting the i-layer 20 is determined by three mechanisms, namely a photoelectric effect, a Compton effect and an electron-hole pair generation. FIG. 6 is a characteristic chart showing an example of relationship between an X-ray energy irradiating Si or Ge and an absorption rate thereof.

Medical and analytical applications usually employ an X-ray of an energy of 0.1 MeV or less, and, by referring to FIG. 6 for such case, it can be known that the absorption in the semiconductor is mainly determined by the photoelectric effect.

Then, in the case of a radiation detection by a pn junction or a pin junction of a semiconductor, the detection of the radiation is influenced by a dark current resulting from a diffusion of the carriers.

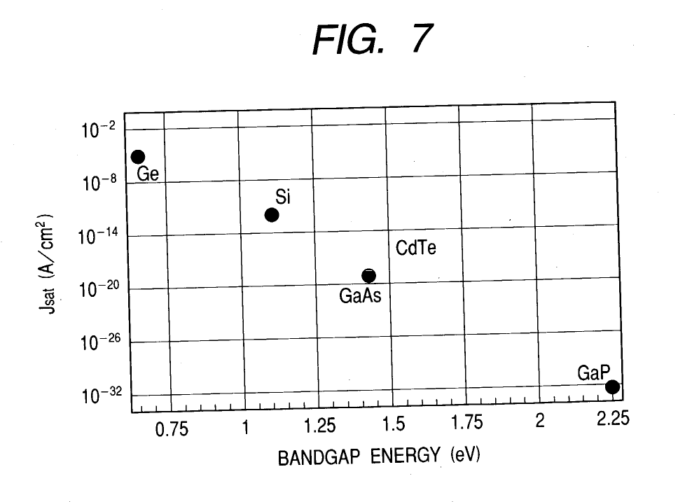

FIG. 7 is a characteristic chart showing a relationship between a dark current resulting from a pn or pin junction and a band gap energy. As shown in FIG. 7, the dark current depends on the band gap energy. Also in the case the band gap energy is smaller than 1 eV, the dark current density by a diffusion current becomes 10⁻¹⁰ A/cm² or higher even in the use at the room temperature. As a result, the noise characteristics are deteriorated and a special measure therefor is required.

In general, a material with a larger atomic number has a higher absorption coefficient for X-ray. Consequently, there is desired a material having a band gap energy of 1 eV or larger, a small dark current in a pn or pin junction, and a large atomic number with a large absorption coefficient for X-ray. In this regard, GaAs or Gap is more preferred than Si as a radiation detecting material.

Furthermore, the dark current resulting from diffusion becomes even smaller in a pipn junction or a pnin junction including a carrier diffusion preventing layer as in the radiation detecting element of the present embodiment. Si may be used for a lower energy in consideration of a relatively small absorption coefficient for X-ray as shown in FIG. 6.

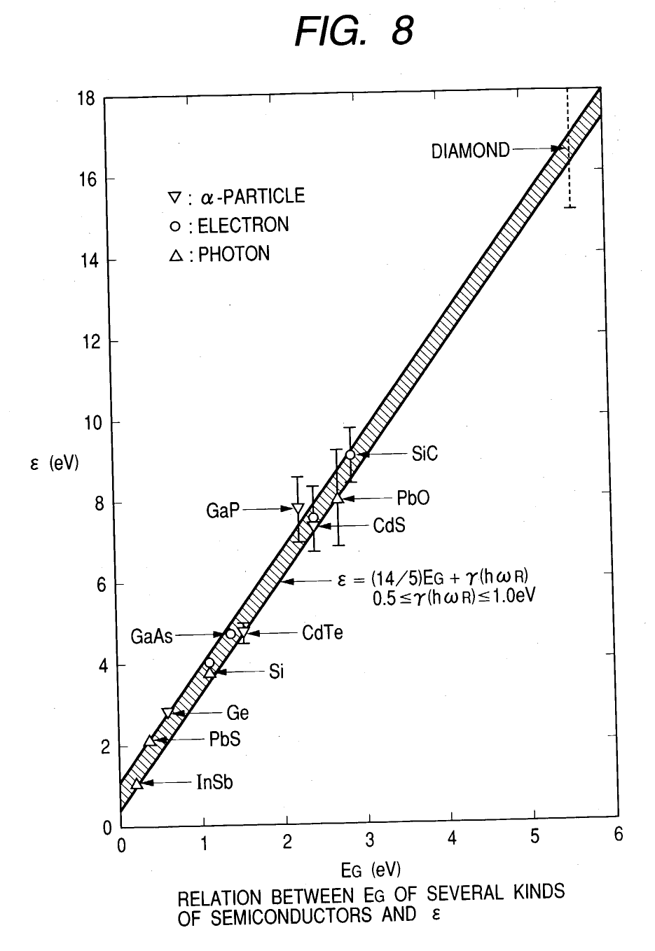

Then, FIG. 8 is a characteristic chart showing a radiation energy required for generating carriers when a semiconductor is irradiated with a radiation. In FIG. 8, the abscissa indicates a band gap energy of the semiconductor while the ordinate indicates an energy required for carrier generation. For a constant energy of the radiation, there is preferred a smaller energy required for carrier generation, since a larger number of carriers can be generated.

As shown in FIG. 8, the energy required for carrier generation is about 5 eV in GaAs or CdTe. Consequently, from an X-ray energy of 50 keV, there can be generated 10,000 pairs of the carriers. GaAs and CdTe are desirable as X-ray detecting material since they have a band gap larger than 1 eV, a small energy ε (eV) required for carrier generation and a large absorption coefficient of X-ray.

Further, GaAs is desirable as a material to be used, since it has a high crystalline completeness and a small dark current. Also GaAs has X-ray absorbing characteristics very close to those of Ge. In consideration of these properties, GaAs can be advantageously employed in a medical application in which the radiation dose of X-ray is limited. GaAs has a satisfactory mass producibility currently similar to that of Si and is very advantageous economically.

In the following, a conversion from radiation to carriers will be explained.

In the radiation detecting element shown in FIG. 1, the n-layer 30 and the p-layer 10 have an extremely low sensitivity to the radiation (X-ray in the present embodiment) and scarcely execute conversion from the radiation to the carriers. The conversion from the radiation to the carriers is effectively executed in a depleted area in the i-layer 20.

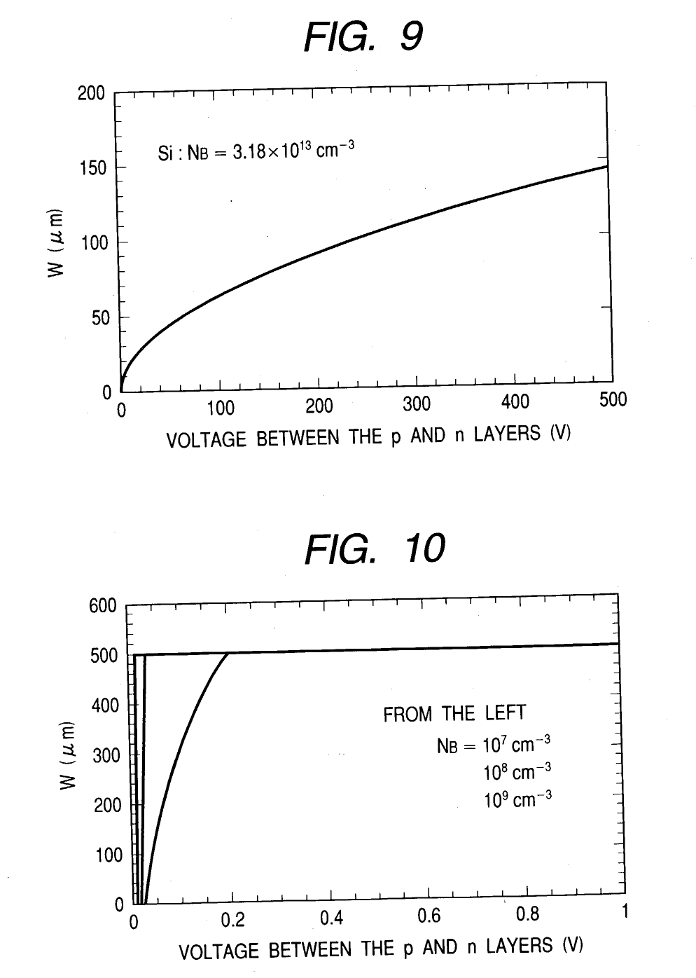

FIG. 9 is a characteristic chart showing a relationship between a voltage applied to the depletion layer in the case of Si and a thickness of the depletion layer. FIG. 9 shows characteristics in the case the i-layer 20 has a background electron concentration of 3.18×10¹³ cm⁻³. FIG. 9 indicates that the thickness of the depletion layer only increases by about 150 μm even under a voltage application of 500 V.

In the following GaAs is considered in comparison with other materials. FIG. 10 is a characteristic chart showing a relationship between a voltage applied to the depletion layer in the case of GaAs and a thickness of the depletion layer. In the case of GaAs, since there can be prepared a wafer with N_{B}=10⁷ cm⁻³, a thicker depletion layer can be obtained with a lower application voltage as shown in FIG. 10, in comparison with Si, whereby the sensitivity to the radiation can be made higher. Also GaAs, having X-ray absorbing characteristics similar to Ge, is suitable as a direct X-ray detecting material.

(Second Embodiment)

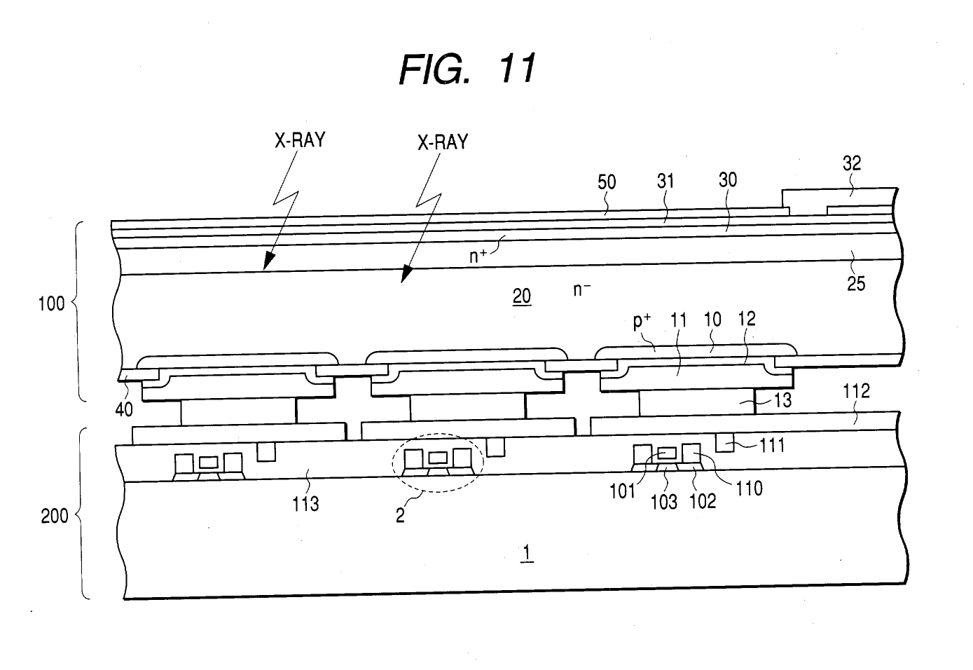

In the following a radiation image pickup apparatus of a second embodiment of the present invention will be explained. FIG. 11 is a schematic cross-sectional view of a radiation image pickup apparatus of the second embodiment of the present invention, wherein an X-ray sensing unit 100 generates electrons and holes in response to an X-ray irradiation. Either of thus generated carriers is accumulated and is read out as a signal including image information. A readout unit 200 for the electrical carriers is constituted by forming a transistor 2 etc. on an insulating substrate.

The X-ray sensing unit 100 is formed by a p-layer 10 of a concentration p⁺ constituted by a semiconductor such as GaAs, GaP, Ge or Si, an i-layer 20 constituting an n-layer, a p-layer 25 of a concentration p⁺, and an n-layer 30 of a concentration n⁺, and a depletion layer is formed by a pipn diode spreading at an interface of the p-layer 10 and the i-layer 20, metal layers 31, 32 formed on the n-layer 30 and metal layers 11, 12 formed under the p-layer 10. The metal layer 12 serves as a barrier metal. In FIG. 11, there are also shown protective films 40, 50. The X-ray sensing unit 100 can be formed on a single crystal substrate of the aforementioned semiconductor.

A readout unit 200 includes a transistor 2 constituting a circuit on the insulating substrate 1. The transistor 2 is formed by a gate 101, a source and a drain 102, an active layer 103, and a metal wiring 110 connected with the source and the drain 102. The transistor 2 is covered with a protective film 113.

As a semiconductor material constituting the thin film transistor, a non-single crystal material such as amorphous silicon, polysilicon or microcrystalline silicon can be advantageously employed. These materials can be formed on a large-sized glass substrate with a low temperature not exceeding 400° C., and are optimum for a radiation image pickup apparatus utilizing a large-sized substrate and having a large sensor area.

Referring to FIG. 11, there are shown an Al layer 111 and a metal layer 112. Though not shown in FIG. 11, the readout unit 200 also has a capacitor. The metal layer 112 of the readout unit 200 and the metal layer 11 of the X-ray sensing unit 100 are connected by a bump metal 13.

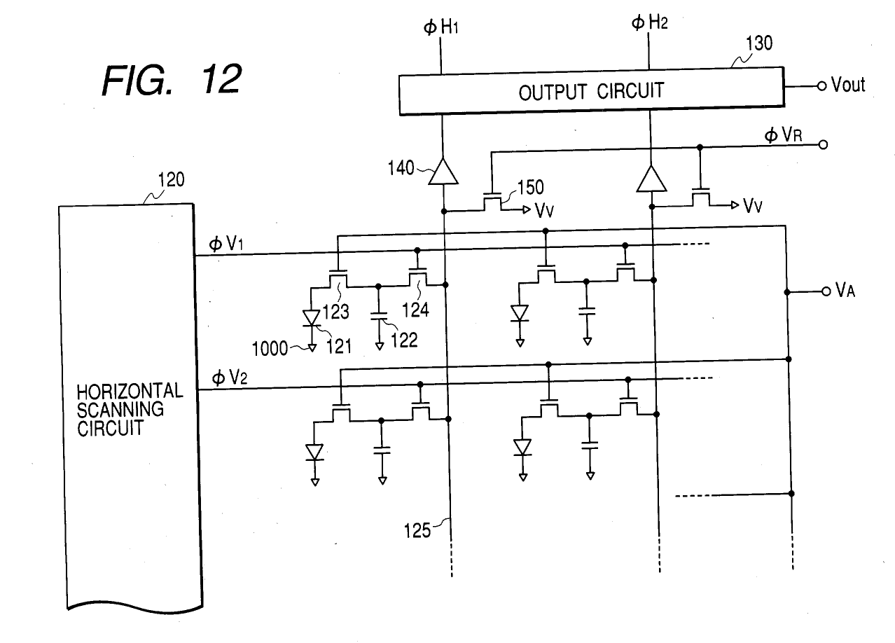

FIG. 12 is an equivalent circuit diagram of the radiation image pickup apparatus of the present embodiment. In FIG. 12, a unit cell constituting an input pixel includes a radiation detecting element 121 constituting charge conversion means, an accumulating capacitor 122 constituting charge accumulation means, a first transistor 123 constituting control means for controlling an electric field applied to the radiation detecting element 121, and a second transistor 124 constituting readout means for reading a signal from the accumulating capacitor 122. The unit cells constituting the input pixels are arranged, as shown in FIG. 12, in vertical and horizontal directions with a desired pitch to form a two-dimensional matrix.

The radiation detecting element 121 shown in FIG. 12 is connected, at another end which is not connected to the first transistor 123, with sensor potential fixing means for giving a desired potential to such another end of the radiation detecting element 121. Also the accumulating capacitor 122 is connected, at another end which is not connected to the first transistor 123 or the second transistor 124, with accumulating potential fixing means for fixing the potential of such another end of the accumulating capacitor 122.

Presence of such means for maintaining a terminal of the radiation detecting element at a desired potential allows to reduce a retentive image therein. Such means can also be operated as means for sweeping an excessive charge accumulated in the accumulation means in the case of an excessive input of radiation. In this manner there can be prevented a carrier overflow through the charge readout means.

A horizontal scanning circuit 120, constituting scanning means such as a shift register as shown in FIG. 12, selects the second transistor 124 of each unit cell in each row, whereby a signal is read from the accumulating capacitor 122 of each unit cell to an output line 125. This signal is also supplied, through an amplifier 140 connected to the output line 125, to an output circuit 130, from which the signal is outputted in succession for a column at a time. Each output line 125 is set at a potential Vv by an output line reset transistor 150.

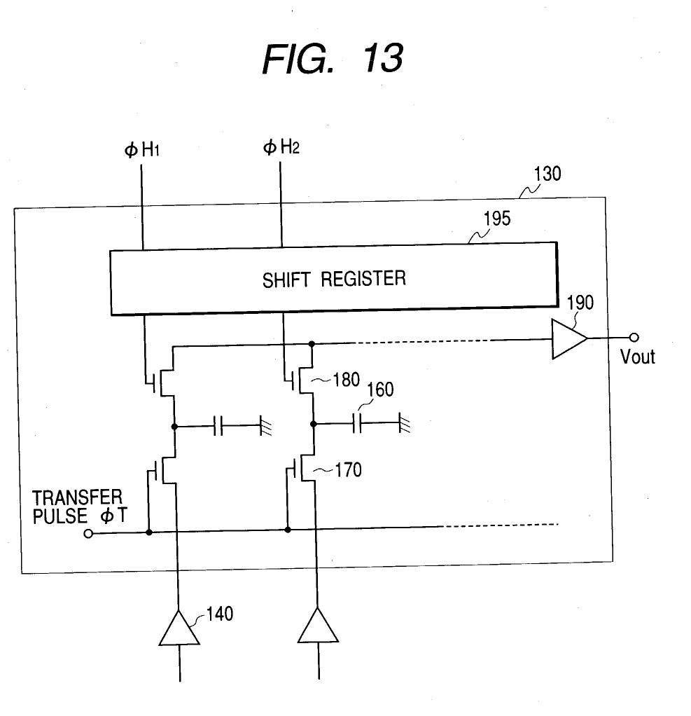

In the following there will be given a detailed description on the output circuit 130 shown in FIG. 12. FIG. 13 is a view showing an example of the configuration of the output circuit. As shown in FIG. 13, the output circuit 130 includes a sampling accumulation capacitor 160 provided for each output line 125 and a transistor 170 connecting such sampling accumulation capacitor 160 and a common output line.

In the output circuit 130, electrical signals from the output lines 125 are accumulated in succession in the sampling accumulation capacitors 160 by a transfer pulse φT, and timing pulses φH₁, φH₂, . . . are entered in succession from a shift register 195 of the scanning circuit into transistors 180 in the circuit. Thus the transistors 180 are turned on in succession whereby the signals from the sampling accumulation capacitors 160 in each column are read to a buffer amplifier 190 connected to the common output line and are outputted (Vout).

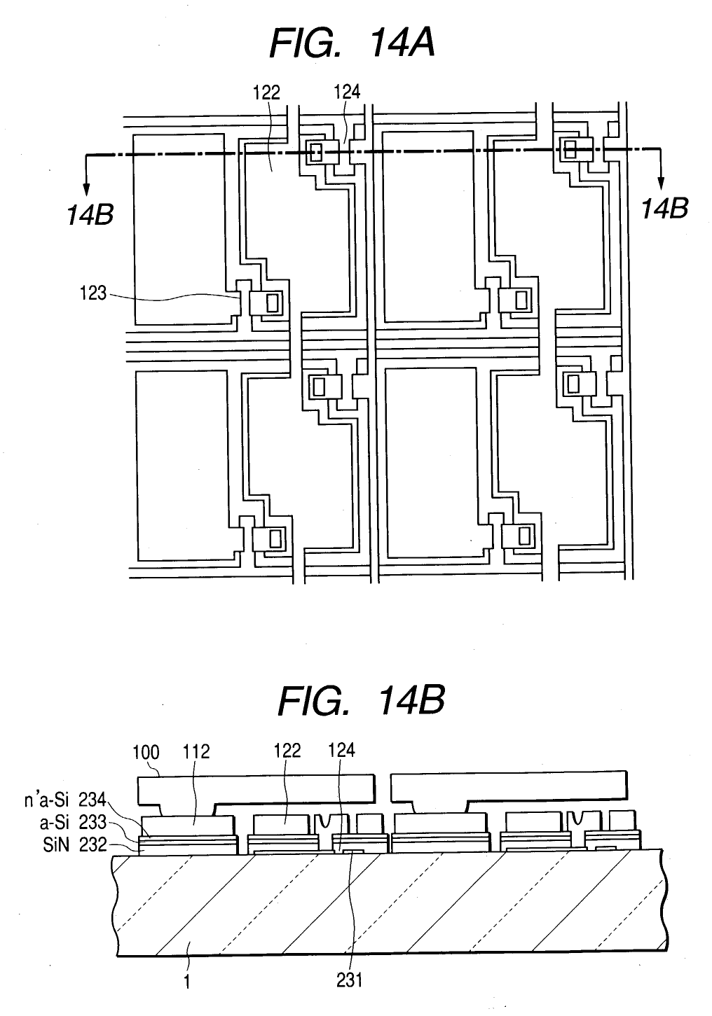

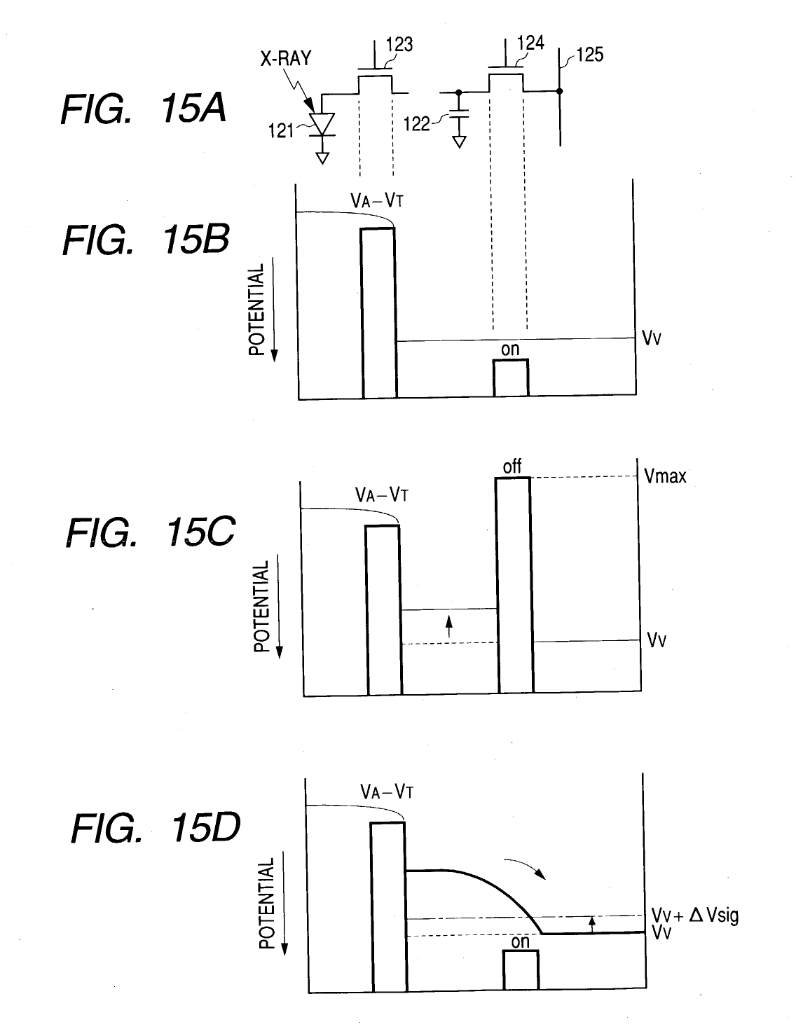

In the following, there will be given a description on the readout unit 200 with reference to FIGS. 14A and 14B, which are a plan view of the readout unit and a cross-sectional view along a line 14B-14B in FIG. 14A, respectively.

As shown in FIG. 14B, the readout unit 200 is formed, on an insulating substrate 1 such as a glass substrate, by a lower electrode 231, an insulation film 232 formed by a silicon nitride film, a high resistance amorphous silicon 233, an n⁺-amorphous silicon 234 and a metal layer 112. Thin film transistors 123, 124 and the accumulation capacitor 122 shown in FIGS. 14A and 14B have a same laminated film configuration. Because of such same laminated film configuration, it is possible to reduce the preparation process, with a low manufacturing cost and an improved production yield.

The metal layer 112 shown in FIG. 14B constitutes one of main electrodes of the transistor 123 shown in FIG. 14A. On the metal layer 112, the X-ray sensing unit 100 is electrically connected. Here is shown an example in which the sensing unit is separated for each pixel.

The thin film transistor circuit of a non-single crystal material formed on the insulating substrate 1 can be formed easily on a large-sized insulating substrate because it is constituted by thin films. Also the thin film transistor, having a thin active layer (normally 0.5 μm or less), has a low probability of radiation absorption, whereby a problem of damage in the material is scarcely generated by a part of the radiation transmitted by the X-ray sensing unit 100 constituting a radiation detecting unit, and it also has excellent noise characteristics because the radiation is scarcely absorbed in the readout circuit thereby generating little noises. For these reasons, it is advantageous to form the circuit with a thin film transistor.

The X-ray sensing unit 100 for the radiation and the readout circuit are formed into a laminated structure across the metal electrode, whereby the X-ray sensing unit has an aperture rate of 100%. Also by forming only the readout circuit on the insulating substrate 1, it is not required to spare an area for the X-ray reception. For this reason, the thin film transistor can have a sufficiently large gate width, thereby achieving a higher operating speed of the thin film transistor. Though variable depending on the characteristics of the semiconductor formed and the number of pixels, it is sufficiently possible to achieve an information reading of 30 FPS (frames per second: 30 image readings per second) to 60 FPS.

In the following there will be explained the function of the radiation image pickup apparatus of the present embodiment, with reference to FIGS. 15A to 15D, wherein FIG. 15A is an equivalent circuit diagram of a unit cell of the radiation image pickup apparatus, and FIGS. 15B to 15D are schematic potential charts showing the functions of the unit cell of the radiation image pickup apparatus, in which the abscissa indicates a position on the unit cell and the ordinate indicates a potential in each position.

FIG. 15B is a potential chart showing a reset state of the unit cell. When the second transistor 124, and the output line reset transistor 150 shown in FIG. 12 are turned on, the potential of the accumulating capacitor 122 is shifted to a reset voltage Vv as shown in FIG. 15B. By giving a constant voltage V_{A} to the gate of the first transistor 123, the first transistor 123 always assumes a potential V_{A}−V_{T}, wherein V_{T} is a threshold voltage of the first transistor.

FIG. 15C is a potential chart showing a signal accumulation state of the unit cell. When X-ray irradiates the radiation detecting element 121 while the transistor 124 is turned off, carriers are generated in the radiation detecting element and are accumulated through the transistor 123 in the accumulating capacitor 122, whereby the potential thereof changes from V_{V}.

FIG. 15D is a potential chart showing a signal readout state of the unit cell. When the transistor 124 is turned on while the output line reset transistor 150 is turned off, the charge accumulated in the accumulating capacitor 122 is read out to the output line 125. In principle, there are repeated the above-explained operations of resetting, signal accumulation and readout of the unit cell.

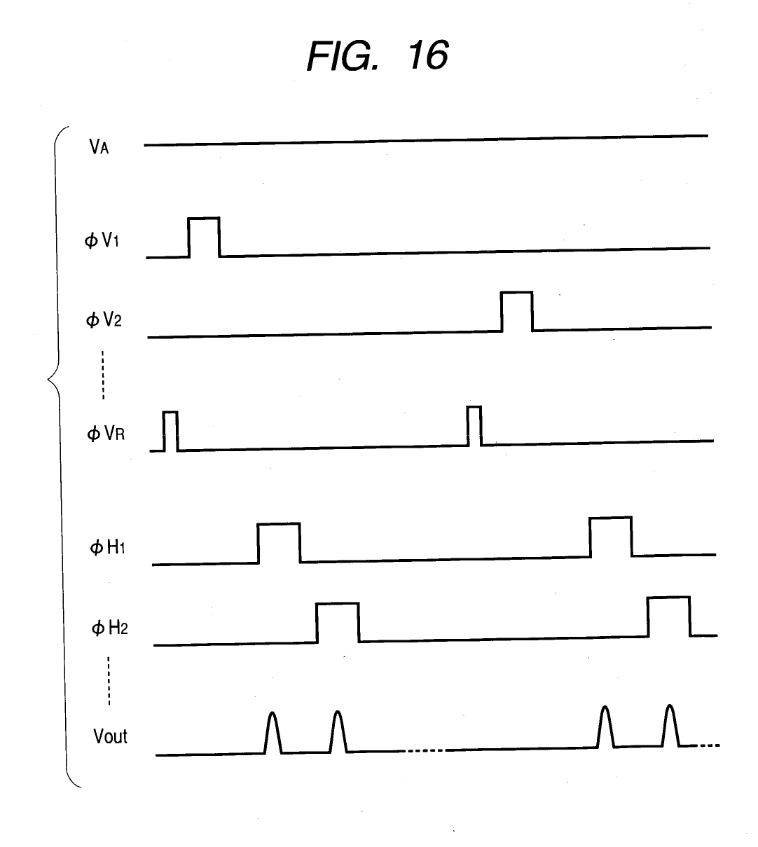

In the following, there will be explained a timing chart of the driving operations of the radiation image pickup apparatus shown in FIG. 16, with reference to the equivalent circuit diagram of the radiation image pickup apparatus shown in FIG. 12. In the following, a constant voltage given to the gate of the first transistor 123 is represented by V_{A}, a voltage of the output line 125 in the resetting operation is represented by V_{V}, and a voltage of the gate (φV_{R}) of the output line reset transistor 150 is represented by V_{R}.

At first, a voltage V_{R} is applied to the gate (φV_{R}) of the output line reset transistor 150, whereby the output line 125 is reset. Then a pulse is applied from the horizontal scanning circuit 120 to φV₁ whereby the second transistor 124 connected thereto reads a signal accumulated in the accumulating capacitor 122 to each output line 125. The horizontal scanning is executed in succession in an order of φH₁, φH₂, . . . whereby outputs (Vout) are obtained in succession from the output circuit 130.

—Variation—

In the following there will be explained a variation of the radiation image pickup apparatus in the second embodiment.

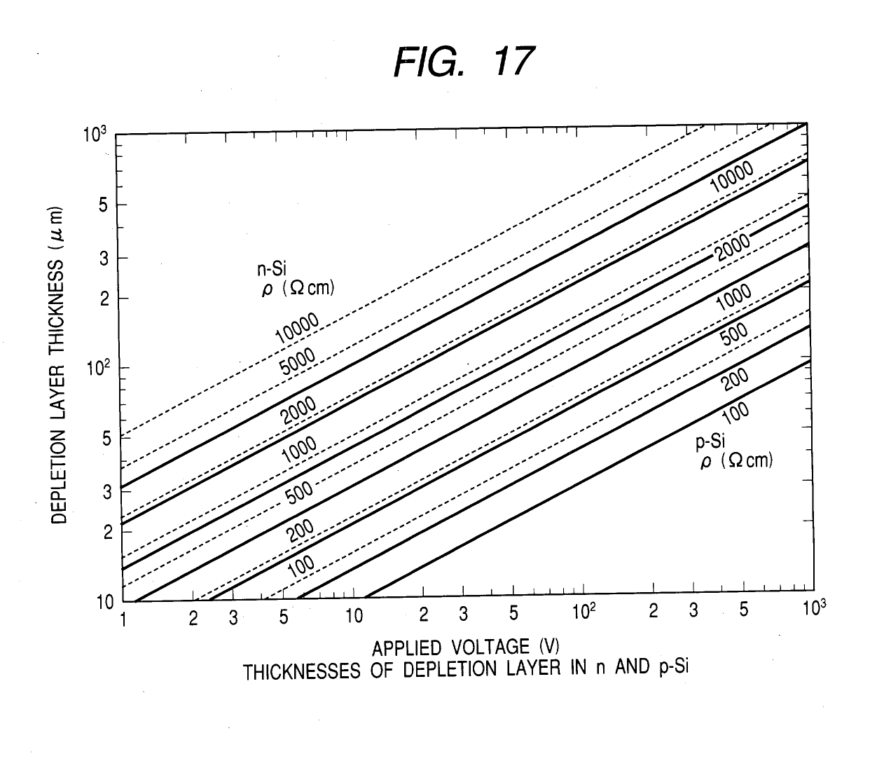

At first, FIG. 17 shows a relationship between an applied voltage and a thickness of the depletion layer, taking a resistivity in n-type or p-type Si as a parameter. In FIG. 17, a solid line shows the resistivity in p-type Si, while a broken line shows the resistivity in n-type Si. It is preferred that the revistivity is 100 Ωcm or higher, and that the applied voltage is 10 V or higher, desirably 100 V or higher.

As shown in FIG. 17, there is required an applied voltage of 1000 V or higher in order to obtain a depletion layer close to 1 mm. On the other hand, in the case of GaAs, since a wafer can be prepared with a resistivity of 10⁷ Ωcm or higher, a thick depletion layer can be obtained with a lower voltage than in the case of Si, so that a higher sensitivity can be obtained. Also GaAs, having X-ray absorbing characteristics similar to Ge, is suitable as a direct X-ray detecting material.

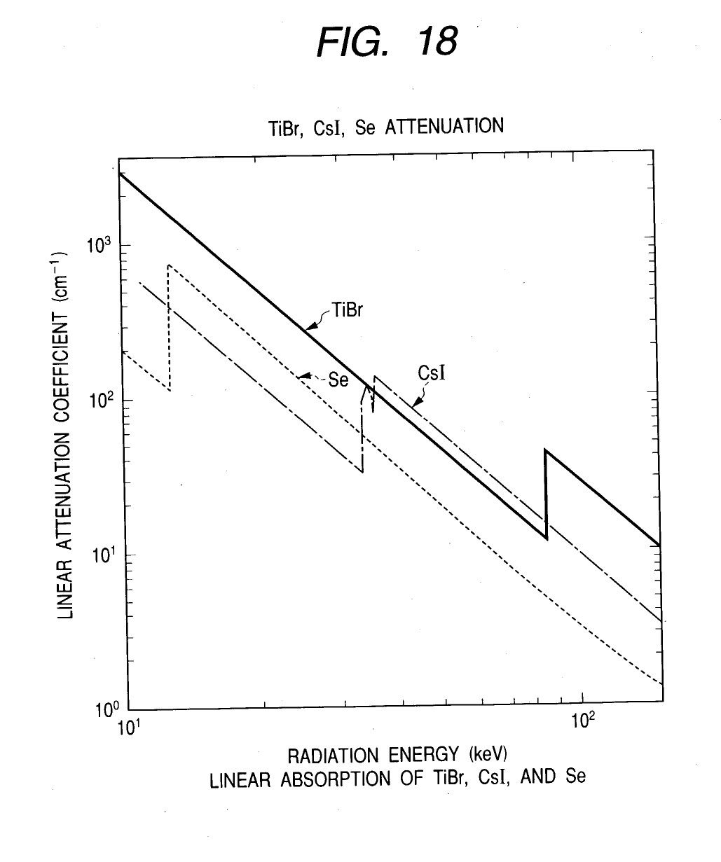

FIG. 18 shows X-ray absorbing characteristics of TiBr, CsI and Se as references, wherein the abscissa indicates the energy of the irradiating X-ray, while the ordinate indicates an attenuation coefficient representing a level of decrease of the output. It will be understood that the X-ray absorption amount decreases with an increase in the energy of the irradiating X-ray. However, the X-ray absorption amount increases stepwise at a certain energy.

As explained in the foregoing, in the case the X-ray sensing unit 100 in the radiation detecting element 121 shown in FIG. 12 is constituted by Si, it is required to apply a voltage of 1000 V or higher to an electrode terminal 1000. On the other hand, in the case of GaAs, there is required an applied voltage lower than in the case of Si.

By always applying a constant voltage V_{A} to the first transistor (thin film transistor: TFT) 123 in FIG. 12, the other electrode terminal of the radiation detecting element 121 always assumes a potential V_{A}−V_{T}. Therefore the radiation detecting element 121 is always given a constant voltage whereby the thickness of the depletion layer remains constant to enable a stable operation.

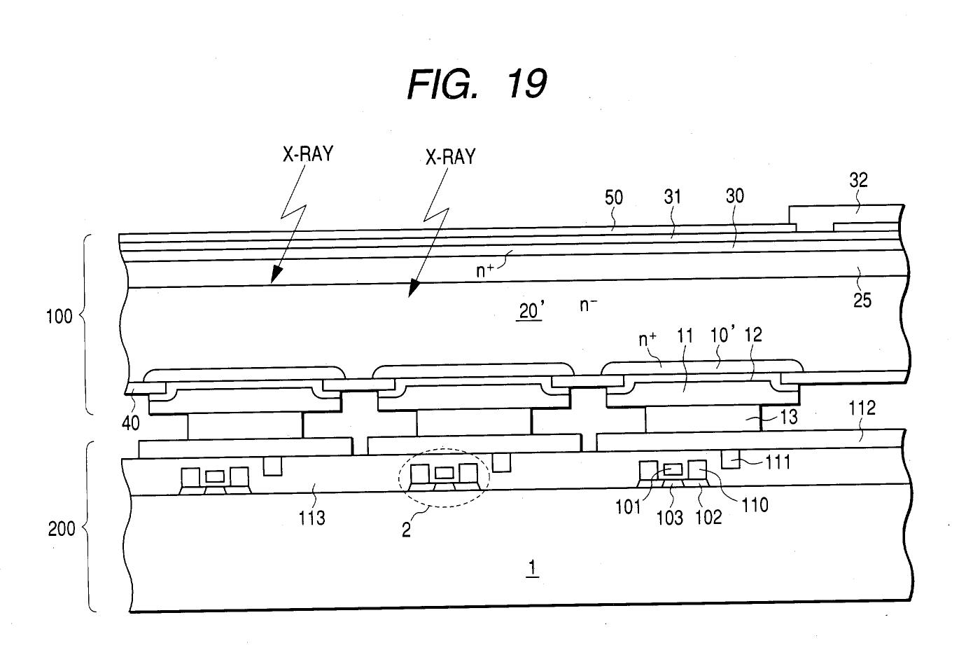

FIG. 19 is a schematic cross-sectional view showing, as a variation of the radiation image pickup apparatus of the present embodiment, a configuration employing a high-resistance semiconductor in the single crystal semiconductor of the X-ray sensing unit 100 shown in FIG. 11. GaAs is particularly suitable for the material of a single crystal high-resistance part 20′ shown in FIG. 19, since it has a high resistivity of 10⁷ Ωcm or higher, and a band gap of about 1.5 eV to provide a low dark current, and can be prepared in a large wafer of about 6 inches in diameter. A numeral 10′ indicates an n⁺-layer.

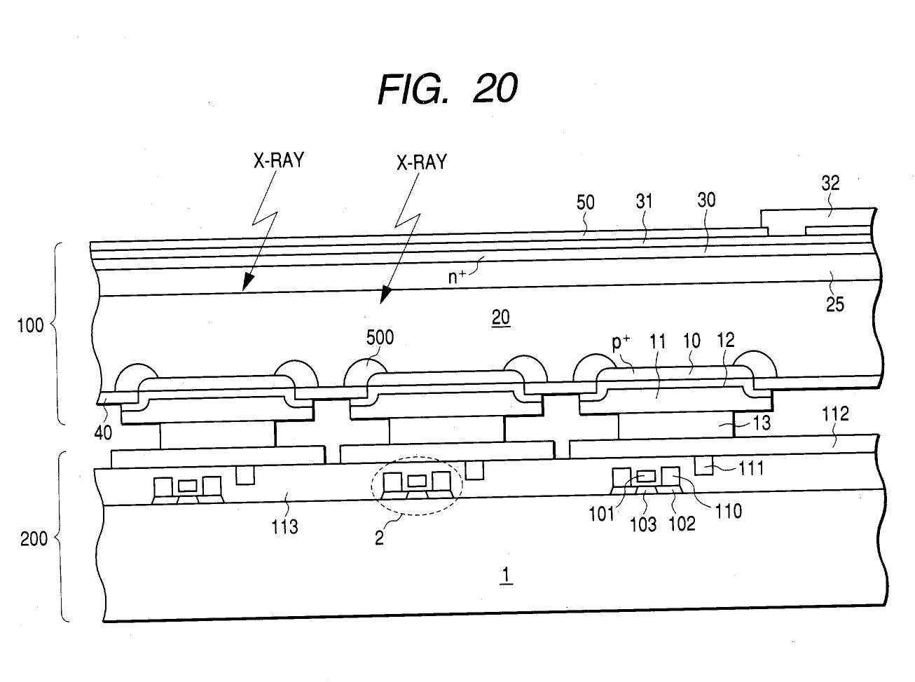

FIG. 20 is a schematic cross-sectional view showing another variation of the radiation image pickup apparatus of the present embodiment. The variation shown in FIG. 20 is provided, around the p-layer 10 in FIG. 11, with a p-type guard area 500 of a concentration lower than the concentration p⁺ of the p-layer 10. Thus, in the case a high voltage is applied to the radiation detecting element 121, it is possible to relax a steep electric field in the peripheral area and to improve the voltage resistance of the pn junction.

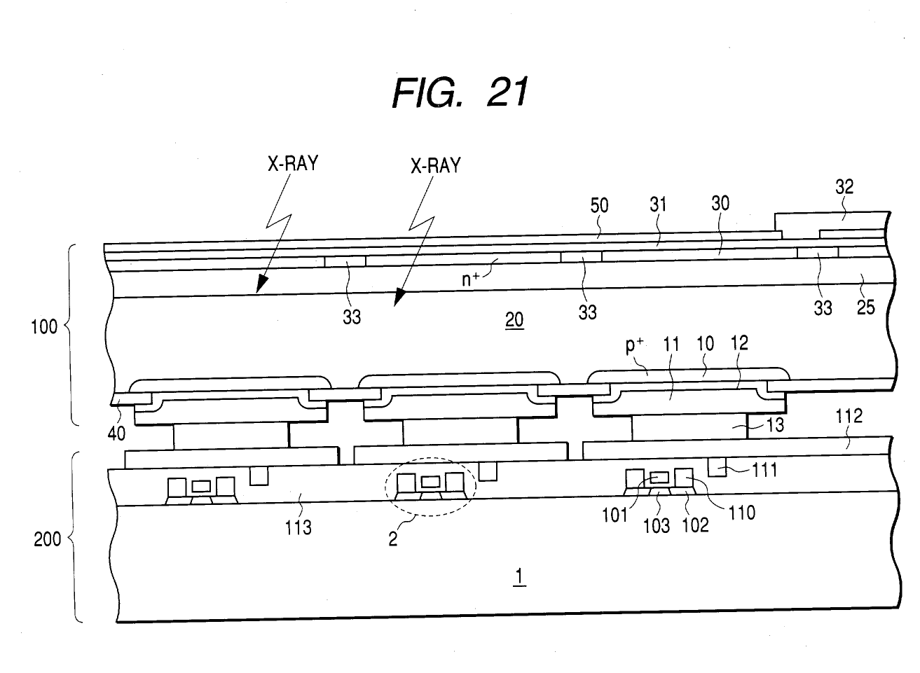

FIG. 21 is a schematic cross-sectional view showing still another variation of the radiation image pickup apparatus of the present embodiment. In the variation shown in FIG. 21, the n-layer 30 shown in FIG. 11 is separated, and such configuration is effective in improving the resolution. A numeral 33 is an insulation film for separating the n-layer 30.

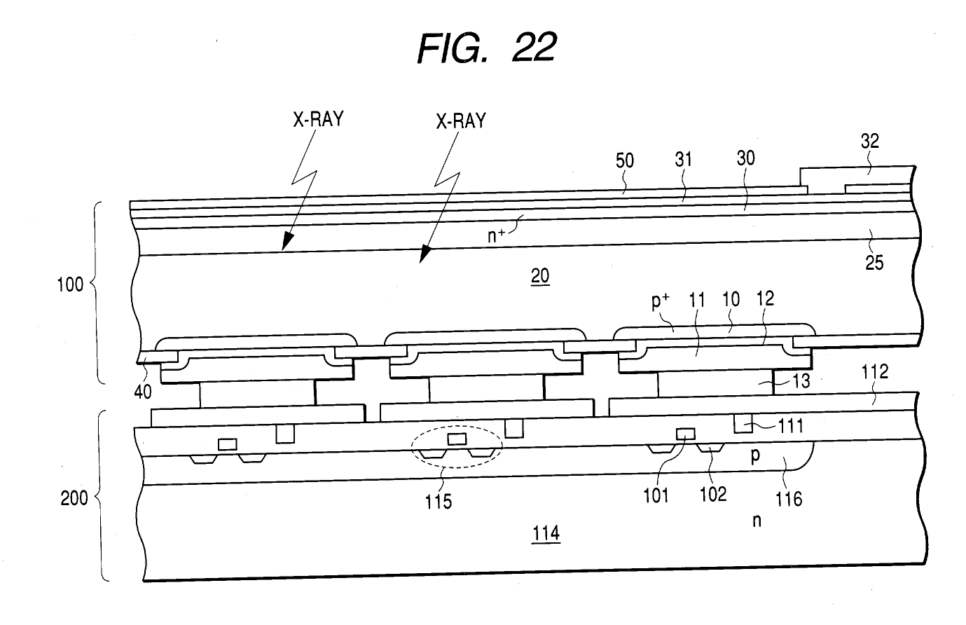

FIG. 22 is a schematic cross-sectional view showing still another variation of the radiation image pickup apparatus of the present embodiment. In the variation shown in FIG. 22, the insulating substrate 1 shown in FIG. 11 is replaced by a single crystal semiconductor substrate. The use of the single crystal semiconductor substrate 114 allows to incorporate the peripheral circuits in such substrate and is effective for achieving higher functions and a high-speed readout. In an example shown in FIG. 22, in the single crystal semiconductor substrate 114, there are formed the source and drain 102 as a n-type area and the gate 104 is formed on a p-type area 116 across an insulation layer to constitute the transistor 115.

(Third Embodiment)

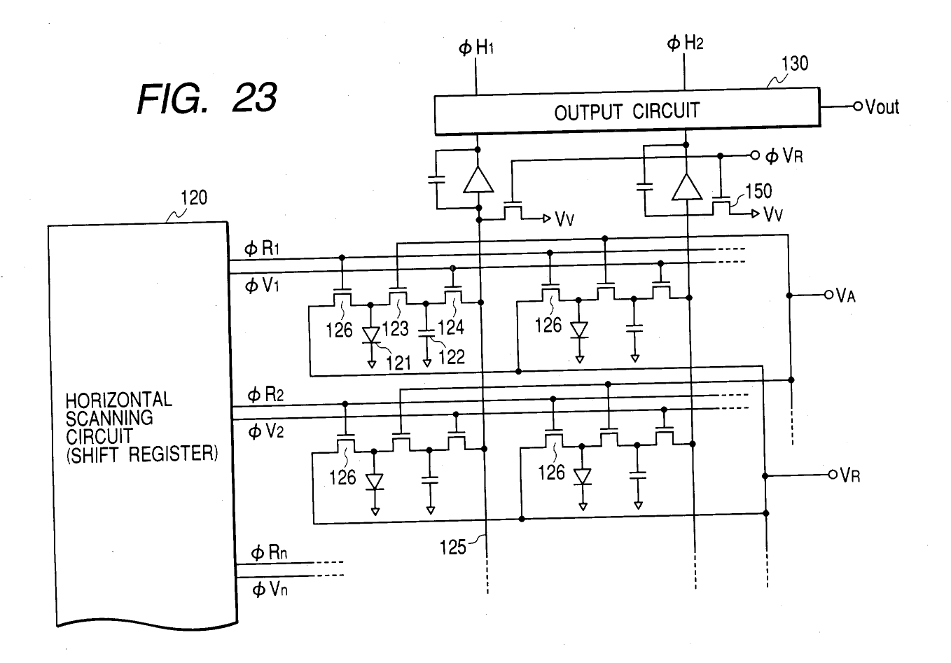

In the following there will be explained a radiation image pickup apparatus of a third embodiment of the present invention. FIG. 23 is an equivalent circuit diagram of the radiation image pickup apparatus of the third embodiment of the present invention. The present embodiment is formed by connecting a reset transistor 126 to a radiation detecting element 121.

The connection of the reset transistor (reset thin film transistor) 126 to the radiation detecting element 121 as shown in FIG. 23 improves the retentive image from the radiation detecting element 121. A radiation image pickup apparatus with a reduced retentive image can be realized by selecting V_{R} slightly larger than V_{A}−V_{T}. The reset transistor 126 functions as potential fixing means for fixing the potential of the radiation detecting element 121 for a certain period.

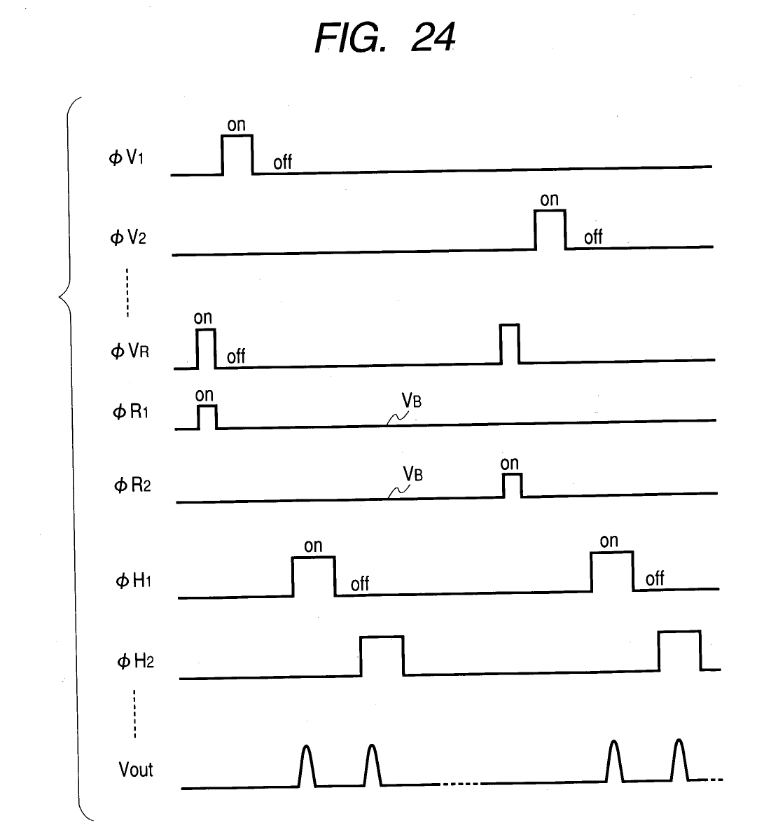

FIG. 24 is a timing chart of a driving operation of the radiation image pickup apparatus of the present embodiment. The horizontal scanning lines φR₁, φR₂, . . . , φV₁, φV₂, . . . are respectively synchronized with φV_{R} to reset the respective unit cells. Also in an off-state of the horizontal scanning lines φR₁, φR₂, they are not completely turned off but a voltage V_{B} is given to the gate of the reset transistor 126 whereby, in the case an intense X-ray enters the radiation detecting element 121 to accumulate a large charge QLange in the accumulating capacitor 122 of a capacitance C1, the voltage of the accumulating capacitor 122 determined by VLange=QLange/C1 does not become larger than V_{B}−V_{T}. In this manner the second transistor 124 can be protected from the application of an excessively large voltage.

Such excessively large voltage means for example a voltage larger than the voltage Vmax applied to the second transistor 124 as shown in FIG. 15C, and, in the case a charge of a voltage exceeding Vmax is accumulated in the accumulating capacitor 122, carriers flow to the output side of the second transistor 124 thereby significantly affecting the image. By giving a voltage V_{B} to the gate of the reset transistor 126 as explained in the foregoing, it is made possible to avoid the influence on the image, similar to so-called blooming phenomenon in a CCD.

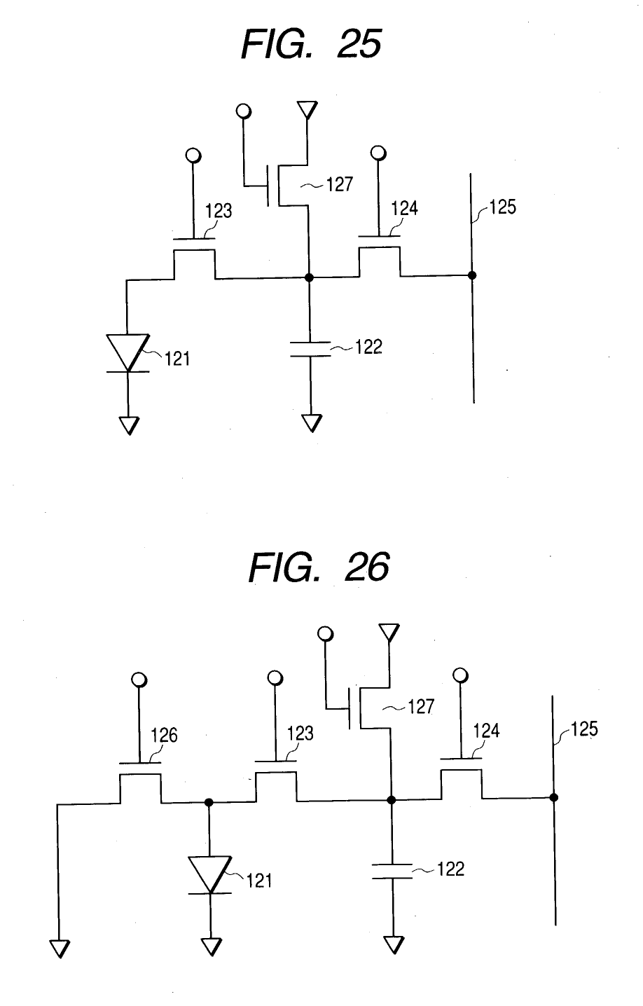

Then, FIG. 25 is an equivalent circuit diagram of a unit cell in the case a reset transistor is provided in the accumulating capacitor 122 of the radiation image pickup apparatus shown in FIG. 23. The reset transistor 127 is operated in the same manner as in the reset transistor 126 shown in FIG. 23, and a voltage V_{B} is given to the gate as explained in the foregoing, whereby the voltage of the accumulating capacitor 122 of the capacitance C1 does not exceed V_{B}−B_{T}.

Also by preventing the overflow of the carriers of the accumulating capacitor 122 to the second transistor 124, there can be improved the image characteristics in the vertical direction. In the case the X-ray dose is sufficiently small, the gate voltage can be set at a completely off potential. Such configuration allows to provide a protecting function in the case of an excessively large X-ray input. Therefore the reset transistor 127 has two functions, namely a function of a reset switch and a function of preventing carrier overflow as a protective circuit.

Then, FIG. 26 is an equivalent circuit diagram in the case reset transistors 126, 127 are provided at the same time.

In this case, by selecting a voltage V_{B} slightly larger or about same as a voltage V_{A}, there is obtained a relation (V_{A}−V_{TH126})=(V_{B}−V_{TH127}), wherein V_{TH126} is a threshold voltage of the reset transistor 126 and V_{TH127} is a threshold voltage of the reset transistor 127.

Thus, a maximum accumulated charge Qmax in the accumulating capacitor 122 becomes:

Qmax=(V_{A}−V_{TH126}−V_{V})·C1.

Also the maximum accumulated charge Qmax can be easily varied by changing the voltages V_{A}, V_{B} and V_{R}. Also the second transistor 124 can be protected from a voltage destruction by setting the voltage V_{B} in consideration of a smaller one of a source-gate voltage resistance (VS−Gmax) of the second transistor and a source-drain voltage resistance (VS−Dmax) thereof.

(Fourth Embodiment)

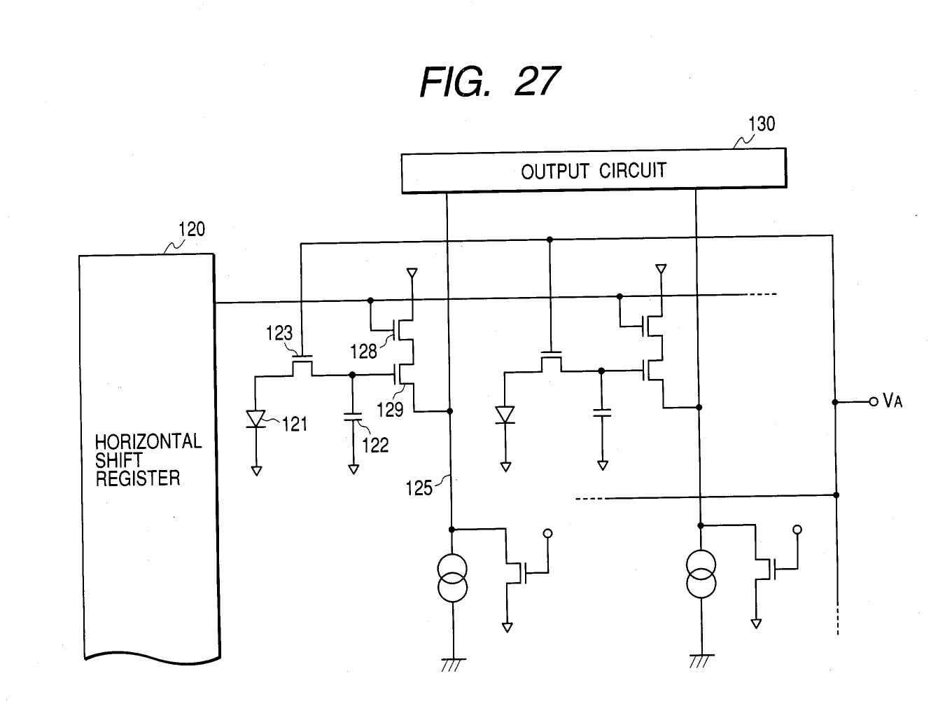

In the following there will be explained a radiation image pickup apparatus of a fourth embodiment of the present invention. FIG. 27 is an equivalent circuit diagram of the radiation image pickup apparatus of the fourth embodiment. The present embodiment provides each unit cell with a source follower to amplify the signal, thereby improving the sensitivity. As shown in FIG. 27, each unit cell is provided with a selecting transistor 128 and an amplifying transistor 129, which constitute a source follower circuit.

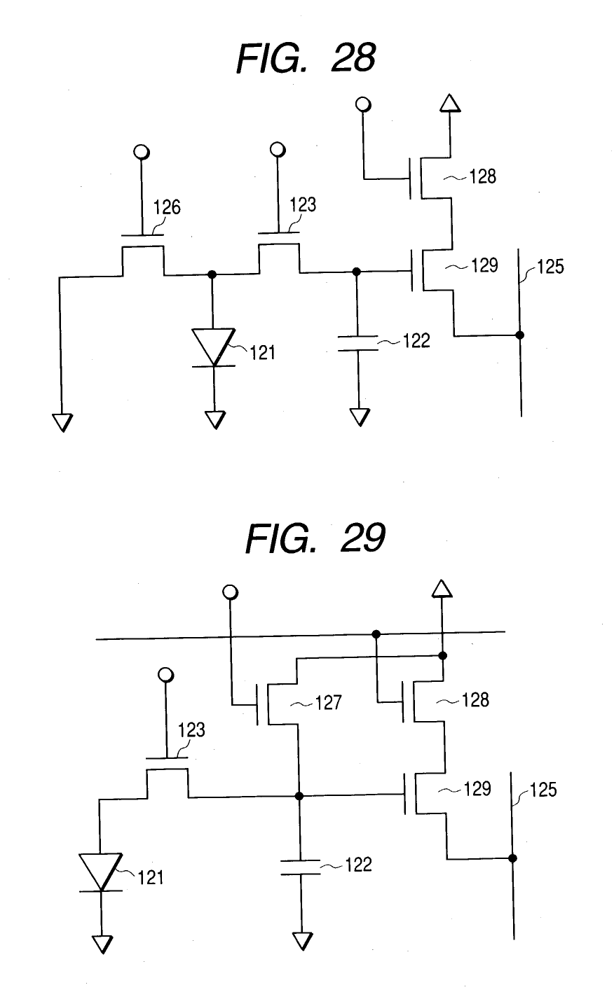

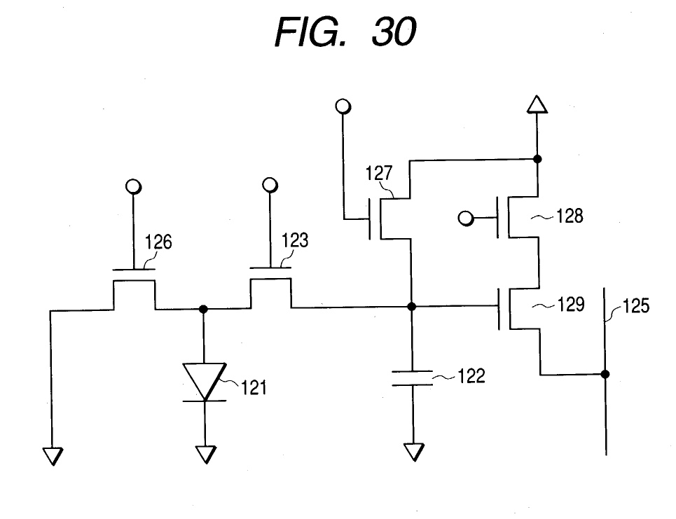

In the following, there will be explained examples of having a source follower in the unit cell of the radiation image pickup apparatus. FIG. 28 is an equivalent circuit diagram of a unit cell in which the aforementioned source follower is provided in the second transistor 124 of the radiation image pickup apparatus shown in FIG. 23. Also FIG. 29 is an equivalent circuit diagram of a unit cell in which the aforementioned source follower is provided in the second transistor 124 of the radiation image pickup apparatus shown in FIG. 25, and FIG. 30 is an equivalent circuit diagram of a unit cell in which the aforementioned source follower is provided in the second transistor 124 of the radiation image pickup apparatus shown in FIG. 26. In the configurations shown in FIGS. 28 and 30, a reduction of the residual image is achieved by providing the reset transistor 126.

(Fifth Embodiment)

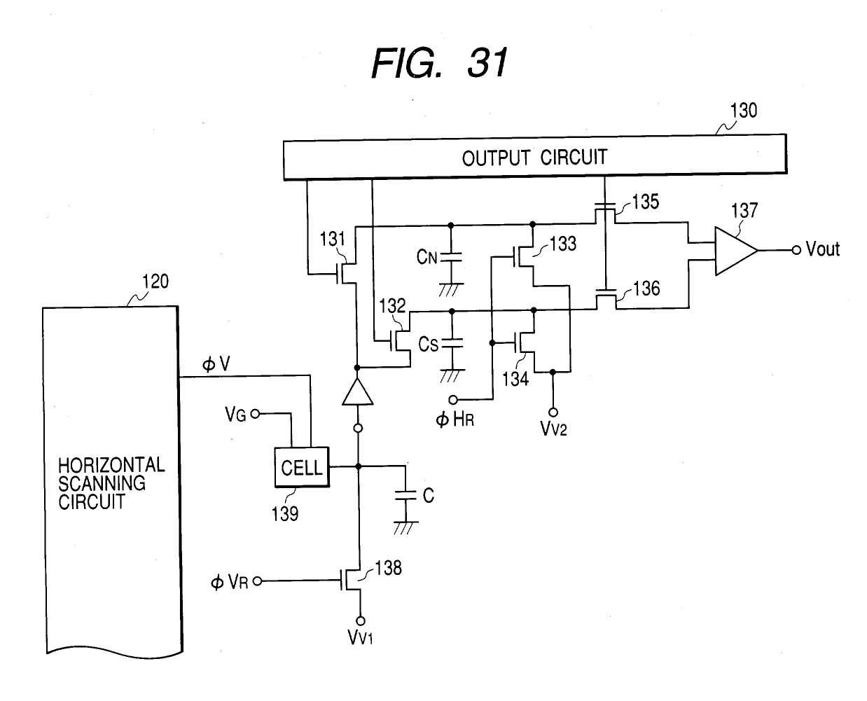

In the following there will be explained a radiation image pickup apparatus of a fifth embodiment of the present invention. FIG. 31 is an equivalent circuit diagram of the radiation image pickup apparatus of the fifth embodiment. The present embodiment is provided with two output systems in order to eliminate a noise of a fixed pattern. Referring to FIG. 31, a signal pulse is given to φV_{R} to turn on a transistor 138, thereby setting a cell 139 and a capacitor C. Thereafter, a noise (N) from the cell 139 after resetting is accumulated in an accumulating capacitor C_{N} through a transistor 131.

Then, after a signal (S) is accumulated in the cell 139, a signal including a noise component (S+N) from the cell 139 is read through a transistor 132 and is accumulated in an accumulating capacitor C_{S}. Then transistors 135, 136 are turned on to read the noise and the noise-including signal, from both accumulating capacitors C_{N}, C_{S}, and a subtracting amplifier 137 provides an output (Vout) of a signal (S) obtained by subtracting the noise component (N) from the signal containing the noise component (S+N).

There are provided a transistor 133 for resetting the accumulating capacitor C_{N} and a transistor 134 for resetting the accumulating capacitor C_{S}. Prior to the resetting of the cell 139, transistors 135, 136 are turned by a signal from φH_{R} to reset the accumulating capacitors C_{N} and C_{S}.

(Sixth Embodiment)

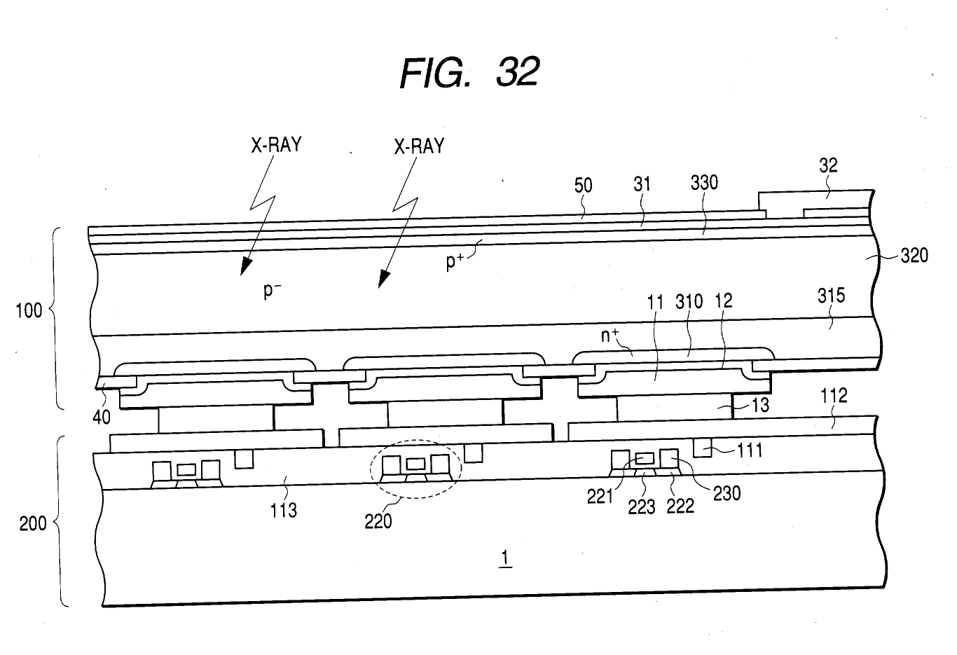

In the following there will be explained a radiation image pickup apparatus of a sixth embodiment of the present invention. FIG. 32 is an equivalent circuit diagram of the radiation image pickup apparatus of the sixth embodiment. In the present embodiment, the charge-emitting i-layer shown in FIG. 11 is constituted as a p⁻-layer instead of an n⁻-layer. In the following description, components having same numbers as in FIG. 11 are equivalent to those explained in FIG. 11 and will not therefore be explained further.

The radiation image pickup apparatus shown in FIG. 32 generates, as explained in FIG. 11, electron-hole pairs from the X-ray irradiating the X-ray sensing unit 100, and either carriers are accumulated and read as an electrical signal bearing image information. As explained in the foregoing, the X-ray sensing unit 100 is constituted with a semiconductor material such as GaAs, GaP or Si, and includes an n-layer 310, a p-layer 315, a charge-emitting i-layer 320 formed as a p⁻-layer, and a p-layer 330. These layers constitute a pin diode with a depletion layer spreading from an interface of the n-layer 310 and the i-layer 320.

In addition, metal layers 31, 32 are formed on the p-layer 330 at the X-ray entry side, and metal layers 11, 12 under the n-layer 310, at the side of the readout unit. As explained before, the metal layer 12 constitutes a metal barrier. Also the X-ray sensing unit 100 may be formed by utilizing the single crystal semiconductor substrate.

The present embodiment is different from the configuration of the second embodiment shown in FIGS. 11 and 12, in a different connecting direction of the diode of the X-ray sensing unit 100.

Also in the radiation image pickup apparatus shown in FIG. 32, the p-layer 330 and the n-layer 310 of the X-ray sensing unit 100 constitute an insensitive area for the radiation. Such configuration enables effective carrier generation in the depletion layer area by the X-ray irradiation.

The readout unit 200 includes an n-type thin film transistor 220 constituting a circuit on the insulating substrate 1, and such n-type thin film transistor 220 includes a gate 221, a source and a drain 222, a semiconductor active layer 223 of a low impurity concentration, and a metal wiring 230 connected with the source and drain 222. The thin film transistor 220 is covered with a protective film 113.

For the semiconductor material of the thin film transistor, as explained in the foregoing, a non-single crystal material such as amorphous silicon, polysilicon or microcrystalline silicon can be advantageously employed. Also the readout unit 200 is provided with a capacitor constituting an accumulating capacitance though it is not illustrated in FIG. 32.

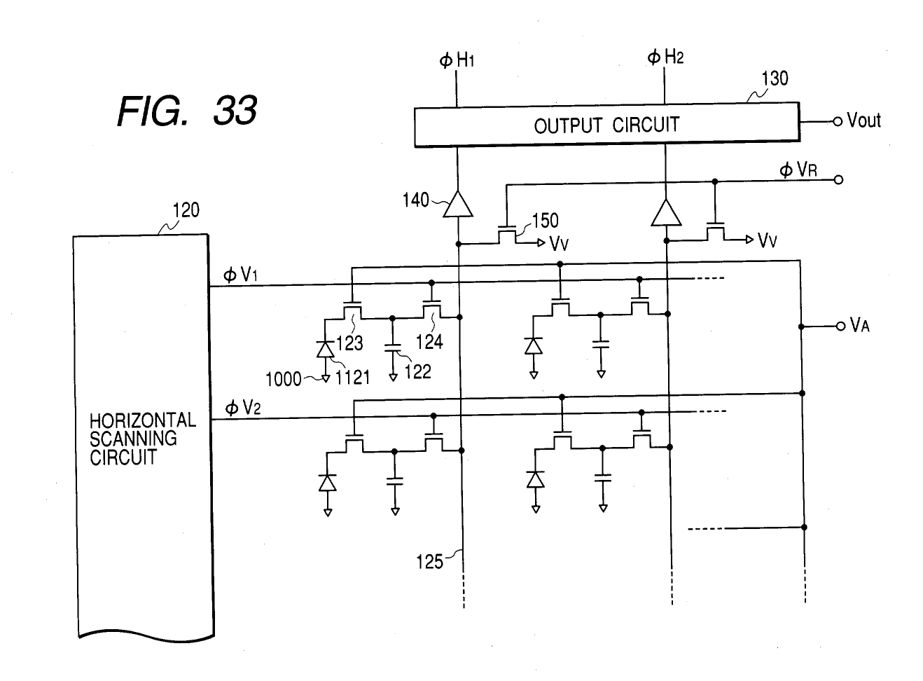

FIG. 33 is an equivalent circuit diagram of the radiation image pickup apparatus of the present embodiment. In FIG. 33, components having same numbers as in FIG. 11 are equivalent to those explained in FIG. 11 and will not therefore be explained further.

Referring to FIG. 33, the unit cell constituting an input pixel includes a radiation detecting element 1121, an accumulating capacitor 122, a first transistor 123 for transferring a signal from the radiation detecting element 1121 to the accumulating capacitor 122, and a second transistor 124 for reading the signal from the accumulating capacitor 122. In FIG. 33, the radiation detecting element 1121 represented as a diode has a polarity different from that in the equivalent circuit diagram in FIG. 12.

The horizontal scanning circuit 120 such as a shift register, shown in FIG. 33, selects the second transistor 124 of each unit cell in each row, whereby a signal is read from the accumulating capacitor 122 of each unit cell to the output line 125, and further supplied through an amplifier 140 connected to the output line 125 to the output circuit 130, which outputs the signals in succession for each column.

The connection of the amplifier 140 to each output line 125 is effective for securing a sufficient signal-to-noise ratio, since, in a radiation image pickup apparatus utilizing a large circuit board (for example 20×20 cm or 43×43 cm) formed on a glass substrate, a parasite capacitance such as a capacitance in a crossing portion of the wirings of the output line 125 and a capacitance between the gate of the thin film transistor and the source connected to the output line 125 is as large as tens to 100 pF in comparison with the charge accumulating capacitance of such radiation image pickup apparatus usually in a range of 0.3 to 5 pF.

Also, each accumulating capacitor 122 and each output line 125 are set at a potential V_{V} by the output line reset transistor 150, through the second transistor 124. The output circuit 130 includes, as shown in FIG. 13, a sampling accumulating capacitor 160 provided for each output line 125 and a transistor 170 connecting the sampling accumulating capacitor 160 and a common output line. The shift register 195 of the scanning circuit enters φH₁, φH₂, . . . in succession to the output circuit 130 to turn on the transistor 180 therein, whereby the signals are read out from the accumulating capacitors of each column to the common output line.

Also a constant voltage V_{A} is always applied to the first transistor 123, whereby the other electrode of the radiation detecting element 1121 always assumes a potential V_{A}−V_{T}. Therefore the radiation detecting element 1121, always given a constant voltage, shows no change in the thickness of the depletion layer and is capable of a stable operation.

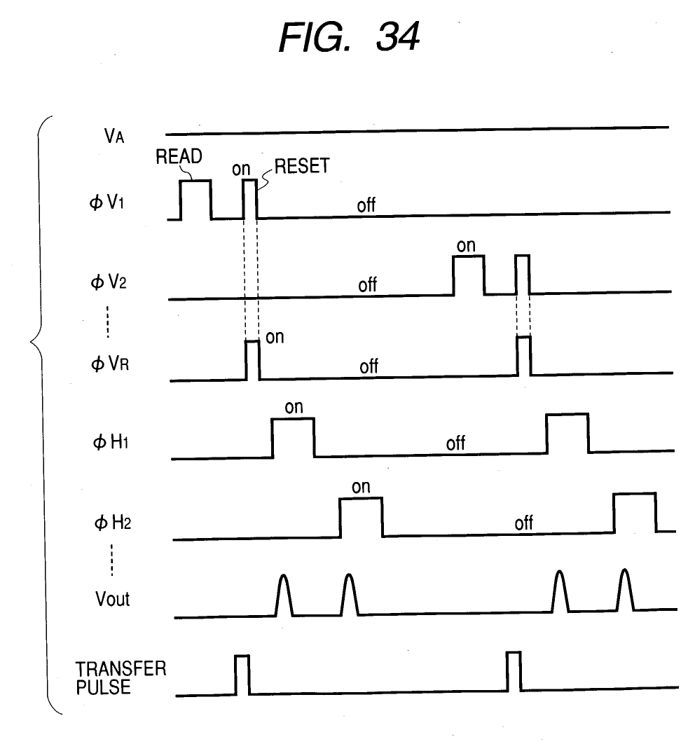

In the following, there will be explained a timing chart of the driving operations of the radiation image pickup apparatus shown in FIG. 34, with reference to the equivalent circuit diagram of the radiation image pickup apparatus shown in FIG. 33. In the following, a constant voltage given to the gate of the first transistor 123 is represented by V_{A}, a voltage of the output line 125 in the resetting operation is represented by V_{V}, and a voltage of the gate (φV_{R}) of the output line reset transistor 150 is represented by V_{R}. A transfer pulse indicates φT in the output circuit 130 shown in FIG. 13.

At first a voltage V_{R} is applied to the gate (φV_{R}) of the output line reset transistor 150 to turn on this transistor, and φV₁ is turned on at the same time, whereby a reset mode is assumed. Thereafter φV_{R} and φV₁ are turned off where by the radiation detecting element 1121 enters an accumulation mode.

Then the horizontal scanning circuit 120 applies a signal pulse to φV₁ whereupon assumed is a readout mode for reading the signal accumulated in the accumulating capacitor 122 to each output line 125. Then the charge is collectively transferred by a transfer pulse to the sampling accumulating capacitor (FIG. 13) in the output circuit 130, and the horizontal scanning operation is executed in succession in an order of φH₁, φH₂, . . . whereby outputs (Vout) are obtained in succession from the sampling accumulating capacitor. After the transfer of the accumulated charge to the output line 125, the reset mode is assumed again.

The above-explained operation cycle is executed similarly for each horizontal line, thereby reading the information in succession. It is also possible to reset the output line 125 only, immediately before φVᵢ (i=1, 2, 3, . . . ) is turned on, by turning on the output line reset transistor 150 of the reset means (φV_{R} being turned on) while the second transistor 124 of the readout means is in an off state (φVᵢ being turned off). In such case, other operations can be executed in the same manner as shown in FIG. 34.

The above-explained operation allows to prevent a phenomenon, in the case an intense X-ray enters a part of the image pickup area of the radiation image pickup apparatus, of a charge leakage from the accumulating capacitor 122 to the output line 125 through the second transistor 124 thereby affecting the signal readout from other cells (known as blooming phenomenon in a CCD).

—Variation—

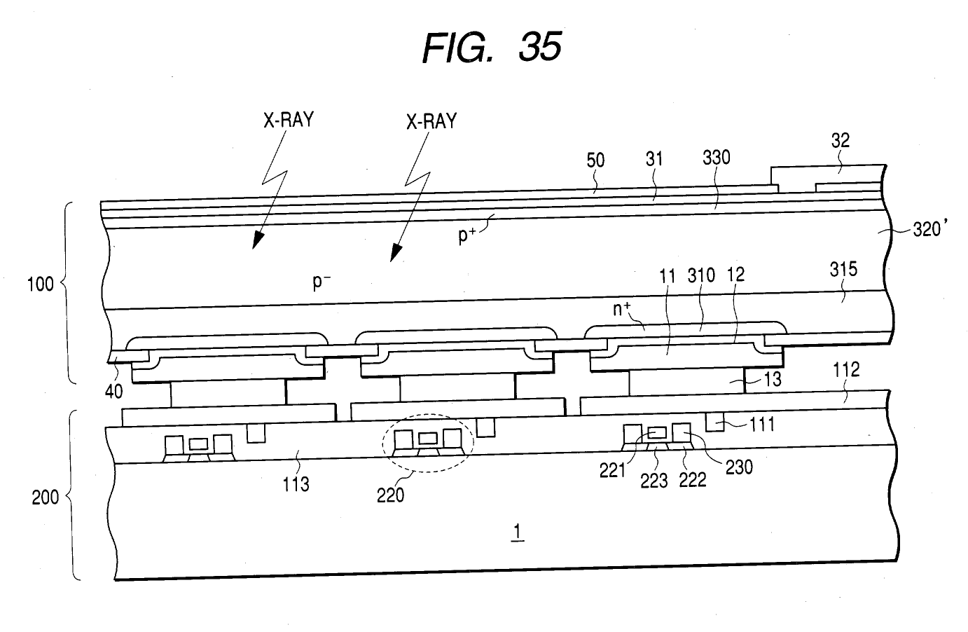

In the following there will be explained a variation of the radiation image pickup apparatus of the sixth embodiment. FIG. 35 is a schematic cross-sectional view showing a variation of the radiation image pickup apparatus of the present embodiment. The variation shown in FIG. 35 employs a high-resistance semiconductor in the single crystal semiconductor of the X-ray sensing unit 100 shown in FIG. 32.

Use of GaAs is desirable as the material of the single crystal high-resistance part 320′ shown in FIG. 35, since it has a high resistivity of 10⁷ Ωcm or higher, and a band gap of about 1.5 eV to provide a low dark current, and can be prepared in a large wafer of about 6 inches in diameter. A numeral 310 indicates an n⁺-layer, and a numeral 330 indicates a p⁺-layer.

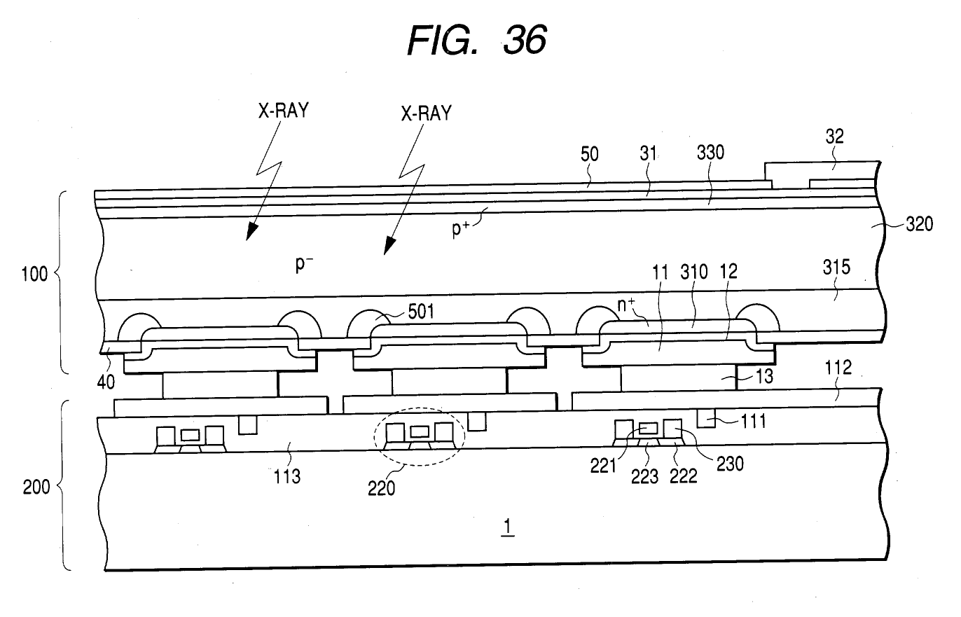

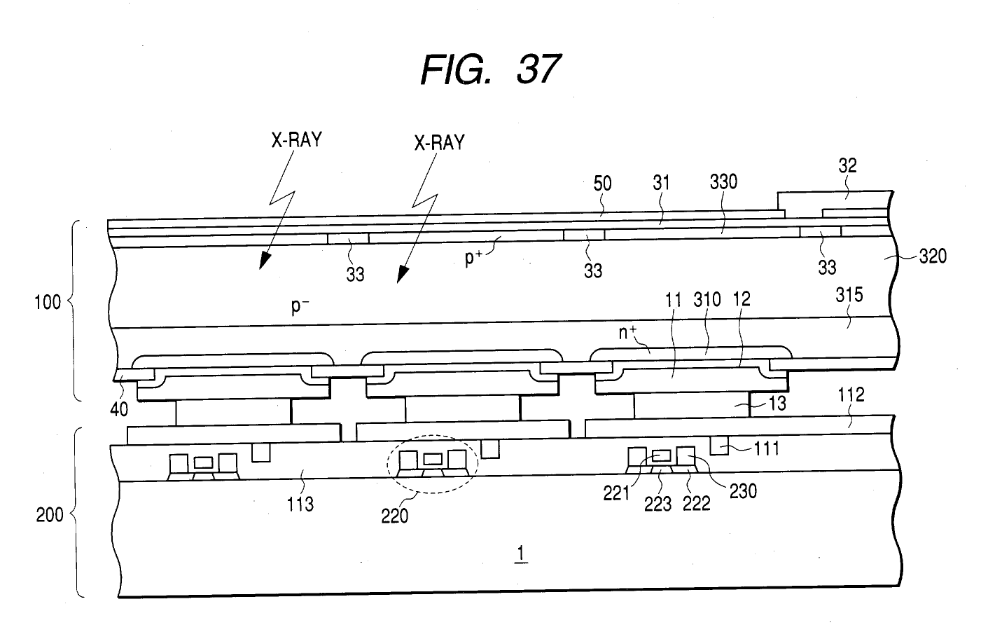

FIG. 36 is a schematic cross-sectional view showing another variation of the radiation image pickup apparatus of the present embodiment. The variation shown in FIG. 36 is provided, around the n-layer 310 in FIG. 31, with an n-type guard area 501 of a concentration lower than the concentration n⁺ of the n-layer 310. Thus, in the case a high voltage is applied to the radiation detecting element 1121, it is made possible to relax a steep electric field in the peripheral area and to improve the voltage resistance of the pn junction.

FIG. 37 is a schematic cross-sectional view showing still another variation of the radiation image pickup apparatus of the present embodiment. In the variation shown in FIG. 37, the p-layer 330 shown in FIG. 32 is separated, and such configuration is effective in improving the resolution. A numeral 33 is an insulation film for separating the p-layer 330.

Also in the configuration shown in FIG. 37, by replacing the charge-emitting i-layer 320 constituted by a p⁻-layer with an n-layer having an opposite conductive type, the depletion layer spreads from the surface side and is securely present in an area where the amount of the incident X-ray is larger, whereby the sensitivity and the resolution can be stabilized. In such case, however, the depletion layer is required to spread over the entire thickness of the i-layer 320 between the p-layer 330 and the n-layer 310.

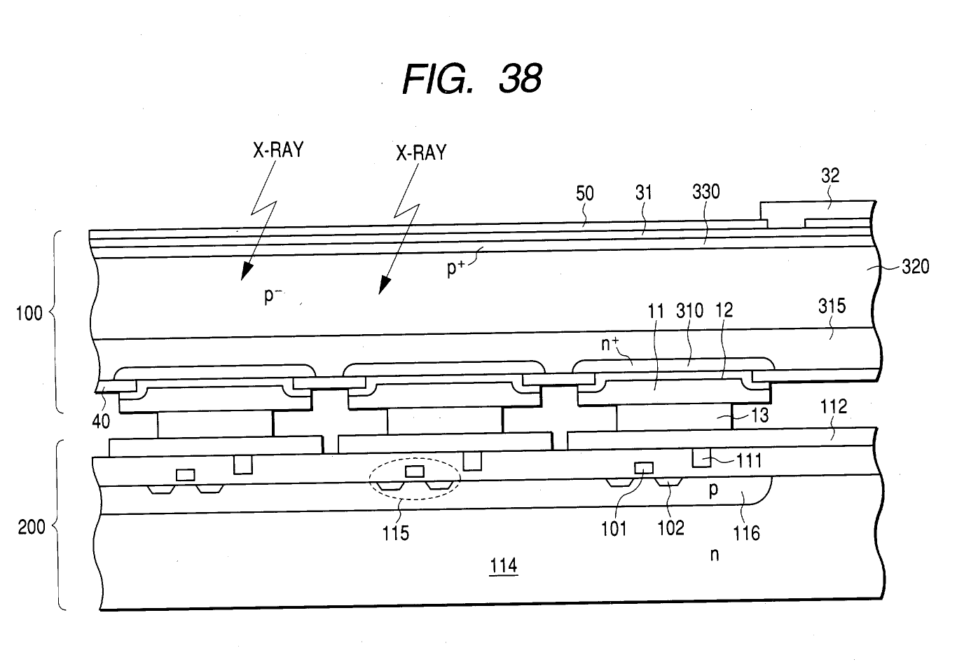

FIG. 38 is a schematic cross-sectional view showing still another variation of the radiation image pickup apparatus of the present embodiment. In the variation shown in FIG. 38, the insulating substrate 1 shown in FIG. 32 is replaced by a single crystal semiconductor substrate. This variation also represents a case where, in the radiation image pickup apparatus, the polarity of the X-ray sensing unit 100 is modified.

The use of the single crystal semiconductor substrate 114 allows to incorporate the peripheral circuits in such substrate and is effective for achieving higher functions and a high-speed readout. A transistor 115 is constituted by forming a gate 101 on a p-area 116 across an insulation layer.

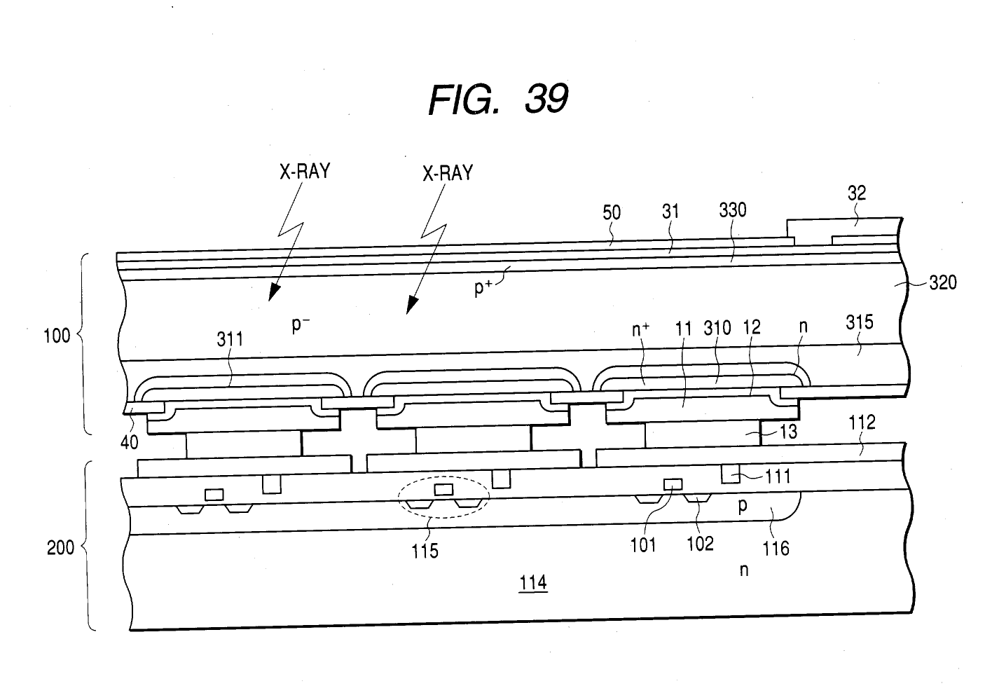

Also FIG. 39 is a schematic cross-sectional view showing still another variation of the radiation image pickup apparatus of the present embodiment. The variation shown in FIG. 39 is provided, in the radiation image pickup apparatus shown in FIG. 29, along the entire periphery of the n-layer 310, with an n-area 311 of an impurity concentration lower than the concentration n⁺ of the n-layer 310. Such configuration reduces an electric field around the n-layer 310 in the pn junction, thereby achieving an improvement in the voltage resistance of the pn junction and a reduction in the dark current in the depletion layer area.

(Seventh Embodiment)

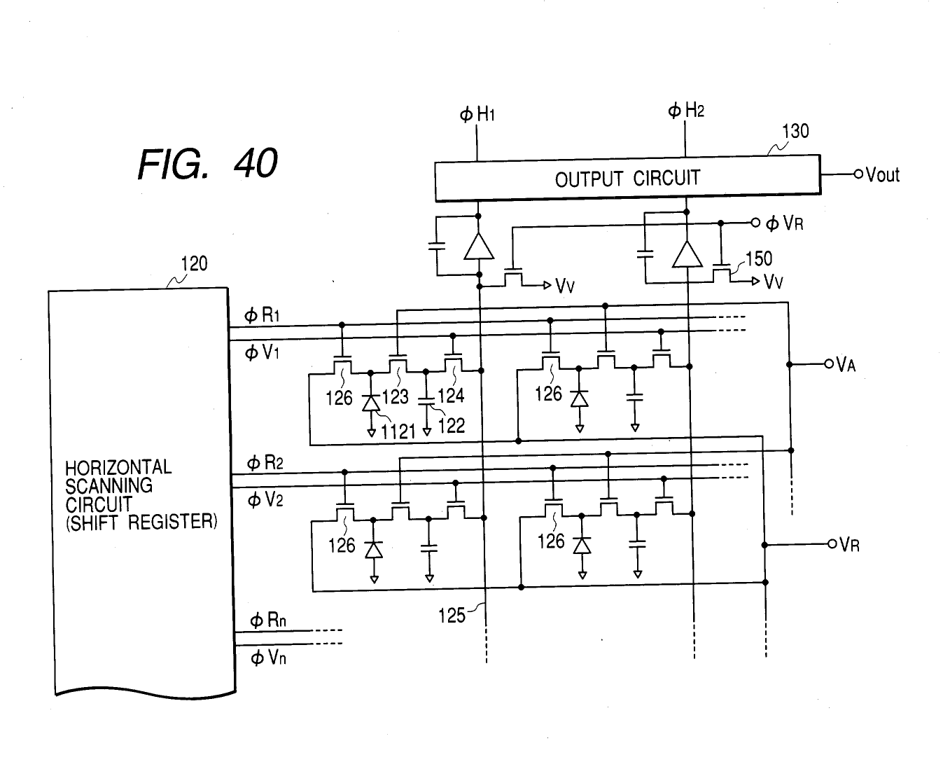

In the following there will be explained a radiation image pickup apparatus of a seventh embodiment of the present invention. FIG. 40 is an equivalent circuit diagram of the radiation image pickup apparatus of the seventh embodiment. The present embodiment has a configuration in which the radiation detecting element 121 shown in the equivalent circuit diagram in FIG. 23 is inverted in polarity. A radiation detecting element 1121 shown in FIG. 40 is similar to that in the radiation image pickup apparatus of the sixth embodiment.

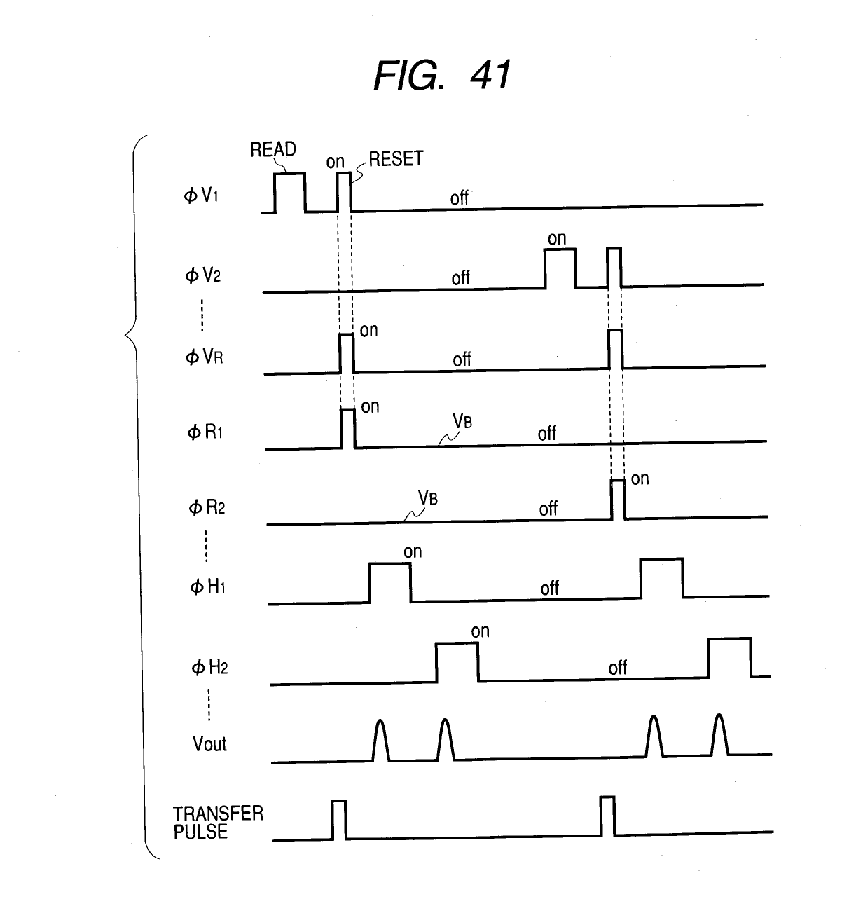

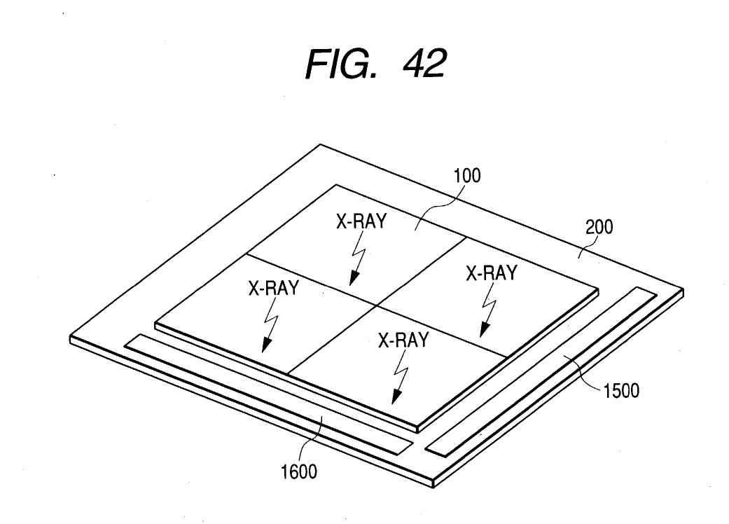

In the following, there will be explained a timing chart,of the driving operations of the radiation image pickup apparatus shown in FIG. 41, with reference to the equivalent circuit diagram of the radiation image pickup apparatus shown in FIG. 40. The transfer pulse indicates φT of the output circuit 130 shown in FIG. 13. The horizontal scanning lines φR₁, φR₂, . . . , φV₁, φV₂, . . . are respectively synchronized with φV_{R} to drive the second transistor 124, the reset transistor 126 and the output circuit 130, thereby resetting the radiation detecting element 1121.

In an off-state of the horizontal scanning lines φR₁, φR₂, the reset transistor 126 is not completely turned off but a voltage V_{B} is given to the gate thereof whereby, in the case an intense X-ray enters the radiation detecting element 1121 to accumulate a large charge QLange in the accumulating capacitor 122 of a capacitance C1, the voltage of the accumulating capacitor 122 determined by VLange=QLange/C1 does not become larger than V_{B}−V_{T}. In this manner the second transistor 124 can be protected from the application of an excessively large voltage.

Such excessively large voltage means for example a voltage larger than the voltage Vmax applied to the second transistor 124 as shown in FIG. 15C, and, in the case a charge of a voltage exceeding Vmax is accumulated in the accumulating capacitor 122, carriers flow to the output side of the second transistor 124 thereby significantly affecting the image. By giving a voltage V_{B} to the gate of the reset transistor 126 as explained in the foregoing, it is made possible to avoid the influence on the image, similar to so-called blooming phenomenon in a CCD.

It is naturally possible also to apply the radiation detecting element 1121 to other configurations as shown by the equivalent circuit diagrams in FIGS. 26 and 30, by inverting the polarity of the radiation detecting element 121.

(Eighth Embodiment)

In the following there will be explained a radiation image pickup apparatus of an eighth embodiment of the present invention. FIG. 42 is a schematic view showing the configuration of a radiation image pickup apparatus of the eighth embodiment of the present invention. In the present embodiment, a large-sized radiation image pickup apparatus is formed by combining plural X-ray sensing units 100 on a readout unit 200 formed on an insulating substrate. In FIG. 42, a driving circuit unit 1500 and an output circuit unit 1600 are provided on the readout unit 200. The image pickup apparatus can be made larger by employing a glass substrate as the insulating substrate of the readout unit 200.

(Ninth Embodiment)

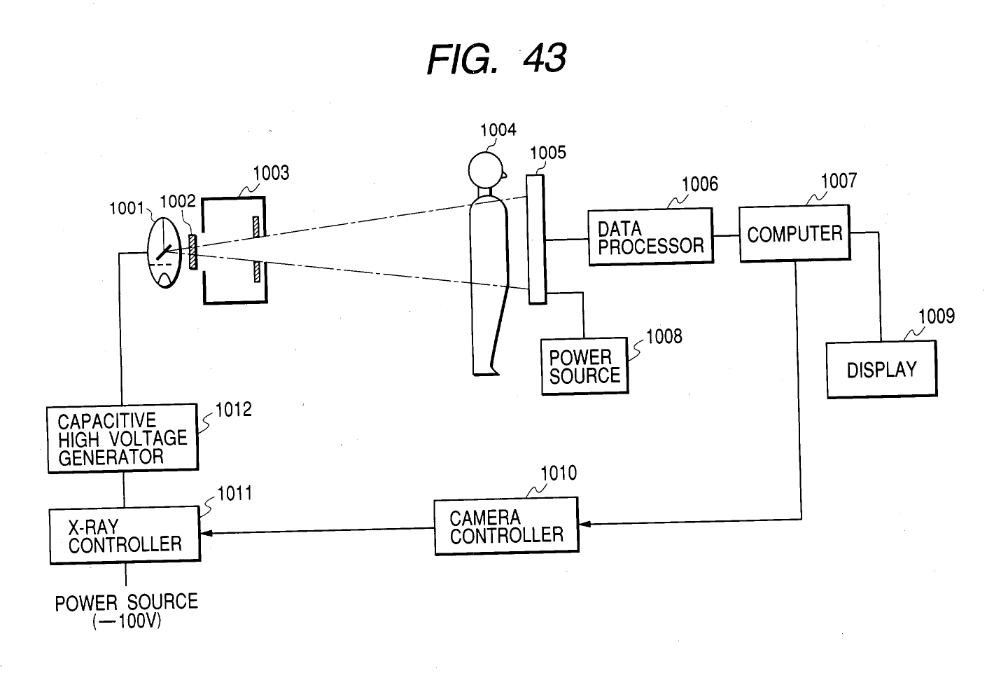

In the following there will be explained a radiation image pickup apparatus of a ninth embodiment of the present invention. FIG. 43 is a schematic view showing an example of a medical diagnostic equipment employing a radiation image pickup apparatus and constituting a ninth embodiment of the present invention. In FIG. 43, there are shown an X-ray bulb 1001 constituting an X-ray source, an X-ray shutter 1002 for transmitting or intercepting the X-ray from the X-ray bulb 10, an irradiation tube or a movable diaphragm 1003, an object 1004, and a radiation detector 1005 embodying the present invention.

A data processing apparatus 1007 processes the signal from the radiation detector 1005. A computer 1007 executes, based on the signal from the data processing apparatus 1007, an X-ray image display on a display device 1009 such as a CRT and a control on the X-ray dose of the X-ray tube 1001 through a camera controller 1010, an X-ray controller 1011 and a capacitor type high voltage generator 1012. In this manner, the radiation image pickup apparatus embodying the present invention can be applied in a system for example for medical diagnosis.

What is claimed is:

1. A radiation detecting element comprising:
a charge emitting layer which absorbs a radiation and emits carriers;
a first semiconductor layer;
a second semiconductor layer of a conductive type opposite to that of said first semiconductor layer;
wherein said charge emitting layer is provided between said first semiconductor layer and said second semiconductor layer; and
a carrier diffusion preventing layer which is provided between said charge emitting layer and at least either of said first semiconductor layer and said second semiconductor layer, thereby preventing a carrier diffusion from said at least either semiconductor layer to said charge emitting layer.

2. A radiation detecting element according to claim 1, wherein said carrier diffusion preventing layer has a conductive type opposite to that of said first semiconductor layer or said second semiconductor layer which forms a junction with said carrier diffusion preventing layer.

3. A radiation detecting element according to claim 1, wherein at least said charge emitting layer is formed by GaAs.

4. A radiation image pickup apparatus comprising:
an input pixel including a radiation detecting element according to claim 1, charge accumulation means which accumulates a charge converted from a radiation by said radiation detecting element, control means which controls an electric field applied to said radiation detecting element and readout means which reads a signal based on the charge accumulated in said charge accumulation means,
an output line for outputting a signal, read by said readout means, from said input pixel; and
reset means which resets said charge accumulation means to a predetermined voltage.

5. A radiation image pickup apparatus according to claim 4, further comprising a guard area for relaxing the electric field, in a periphery of either one of said first semiconductor layer and said second semiconductor layer.

6. A radiation image pickup apparatus according to claim 4, wherein at least said control means, said charge accumulation means and said readout means are formed on a same insulating substrate.

7. A radiation image pickup apparatus according to claim 4, further comprising, in a periphery of either one of said first semiconductor layer and said second semiconductor layer, a semiconductor layer of a same conductive type with an impurity concentration lower than an impurity concentration of said either semiconductor layer.

8. A radiation image pickup apparatus according to claim 4, wherein a semiconductor substrate constituting said radiation detecting element is provided in plural units on an insulating substrate on which at least said control means, said charge accumulation means and said readout means are formed.

9. A radiation detecting method which comprises utilizing a radiation detecting element including a charge emitting layer which absorbs a radiation and emits a charge, and which is provided between a first semiconductor layer and a second semiconductor layer of a conductive type opposite to that of the first semiconductor layer, and preventing, by a carrier diffusion preventing layer provided between said charge emitting layer and at least either of said first semiconductor layer and said second semiconductor layer, a carrier diffusion from said at least either semiconductor layer to said charge emitting layer.

10. A radiation detecting element comprising:
a charge emitting layer which absorbs a radiation and emits carriers;
a first semiconductor layer;
a second semiconductor layer of a conductive type opposite to that of said first semiconductor layer;
wherein said charge emitting layer is provided between said first semiconductor layer and said second semiconductor layer; and
a third semiconductor layer which is provided between said charge emitting layer and at least either of said first semiconductor layer and said second semiconductor layer, and which forms a pn junction with said either semiconductor layer positioned in a vicinity.

11. A radiation detecting element according to claim 10, wherein at least said charge emitting layer is formed by GaAs.

12. A radiation image pickup apparatus comprising:
an input pixel including a radiation detecting element according to claim 10, charge accumulation means which accumulates a charge converted from a radiation by said radiation detecting element, control means which controls an electric field applied to said radiation detecting element and readout means which reads a signal based on the charge accumulated in said charge accumulation means;
an output line for outputting a signal, read by said readout means, from said input pixel; and
reset means which resets said charge accumulation means to a predetermined voltage.
